(19) United States
(12) Patent Application Publication
(10) Pub. No.: US 2015/0134946 A1
(43) Pub. Date: May 14, 2015

(54) SYSTEM, METHOD AND COMPUTER PROGRAM PRODUCT FOR SELECTING AND OFFERING COMPUTATIONAL FUNCTIONALITIES TO A USER

(71) Applicant: HAROLD LEE PETERSON, SCOTTS VALLEY, CA (US)

(72) Inventor: HAROLD LEE PETERSON, SCOTTS VALLEY, CA (US)

(21) Appl. No.: 14/493,004

(22) Filed: Sep. 22, 2014

Related U.S. Application Data
(63) Continuation-in-part of application No. 13/270,169, filed on Oct. 10, 2011, now abandoned.
Application No. 13/270,169 is a continuation-in-part of application No. 12/386,849, filed on Apr. 22, 2009, now abandoned.

(51) Int. Cl. G06F 9/44; G06F 3/0481

(52) U.S. Cl. CPC G06F 9/4401; G06F 3/04817
USPC 713/2

(57) ABSTRACT

A method system and computer product are provided to drive a process that includes powering up the computer; executing a basic input output system procedure; requesting information about and/or from a user; receiving information about and/or from the user; offering access to at least one computational functionality by the computer at least partly on the basis of the received information; and fulfilling the boot-up procedure. The offering of access to at least one computational functionality may include visually presenting an image to the user that when selected directs the computer to launch an associated software program and/or initiate a web service or a communications session. The computational functionality may include or provide accessibility to a web service via the Internet and/or establishing and maintaining a communications session.

### CO-PENDING PATENT APPLICATIONS

The present application is a Continuation-in-Part application of U.S. patent application Ser. No. 11/528,952 filed on Sep. 27, 2006 and titled APPARATUS, METHOD AND COMPUTER-READABLE MEDIUM FOR ORGANIZING THE DISPLAY OF VISUAL ICONS ASSOCIATED WITH INFORMATION TECHNOLOGY PROCESSES, wherein the present application claims benefit of the priority date of the filing of U.S. patent application Ser. No. 11/528,952 filed on Sep. 27, 2006. Furthermore, the U.S. patent application Ser. No. 11/528,952 filed on Sep. 27, 2006 and titled APPARATUS, METHOD AND COMPUTER-READABLE MEDIUM FOR ORGANIZING THE DISPLAY OF VISUAL ICONS ASSOCIATED WITH INFORMATION TECHNOLOGY PROCESSES is incorporated in its entirety within the present application in its entirety and for all purposes.

The present application is in addition a Continuation-in-Part application of U.S. patent application Ser. No. 13/270,169 filed on Oct. 10, 2011 and titled APPARATUS, METHOD AND COMPUTER-READABLE MEDIUM FOR ORGANIZING ICONS ASSOCIATED WITH INFORMATION TECHNOLOGY PROCESSES, wherein the present application claims benefit of the priority date of the filing of U.S. patent application Ser. No. 13/270,169 filed on Oct. 10, 2011. Furthermore, the U.S. patent application Ser. No. 13/270,169 filed on Oct. 10, 2011 and titled APPARATUS, METHOD AND COMPUTER-READABLE MEDIUM FOR ORGANIZING ICONS ASSOCIATED WITH INFORMATION TECHNOLOGY PROCESSES is incorporated in its entirety within the present application in its entirety and for all purposes.

Furthermore, the present application is a Continuation-in-Part application of U.S. patent application Ser. No. 12/386,849 filed on Apr. 22, 2009 and titled SYSTEM, METHOD AND COMPUTER PROGRAM PRODUCT FOR SELECTING AND OFFERING COMPUTATIONAL FUNCTIONALITIES TO A USER, wherein the present application claims benefit of the priority date of the filing of U.S. patent application Ser. No. 12/386,849 filed on Apr. 22, 2009. Furthermore, the U.S. patent application Ser. No. 12/386,849 filed on Apr. 22, 2009 and titled SYSTEM, METHOD AND COMPUTER PROGRAM PRODUCT FOR SELECTING AND OFFERING COMPUTATIONAL FUNCTIONALITIES TO A USER is incorporated in its entirety within the present application in its entirety and for all purposes.

### BACKGROUND OF THE INVENTION

The increasing number of available software products and services, and goods and service available via software-enabled communication, can be overwhelming to a consumer. Many manufacturers of electronics communications enabled devices, e.g., cellular telephones and personal computers, offer third party software and provide offers of sale to goods and services as an aspect of the operation of these devices. In particular, several manufacturers of personal computers receive significant revenue from these third party vendors in return for bundling third party software and offers for sale of goods and services within the user experience of personal computers. The promotion of third party goods and services, to include software and web service purchases, by a device manufacturer after the initial out-of box-experience is another source of revenue to other device manufacturers, e.g., the sales of software, goods and services via the iPhone™ by Apple Computer, Inc. of Cupertino, Calif.

Yet the danger of information clutter can reduce the effectiveness of offers for sale via a computational device, wherein a purchaser or licensee of an electronic device can be annoyed by information overload in the boot process or out-of-box experience with a communications-enabled electronic device. This annoyance can lead to a reduction in user enjoyment of a purchased or leased device, and a negative effect in the incidence of sales of the offered third party software, goods and services. User frustration can be heightened when information provided by a device is perceived by the user to be inappropriate for consideration by the user. This annoyance and frustration can lead some users to disregard offers that might be of interest if offered in a less cluttered process by the device.

In view of the foregoing, there is a long-felt need to protect and strengthen the commercial value of offering software, goods and services to a user of a communications-enabled electronic device.

### SUMMARY OF THE INVENTION

This and other objects of the present invention are made obvious in light of this disclosure, wherein methods, systems and computer program product for enabling a computational device (hereinafter “computer”) to selectively offer access to computational functionalities at least partly on then basis of information regarding, or provided by, a user. According to one aspect of the method of the present invention, the information may include choices provided by the user, selections communicated by the user, descriptions of one or more qualities of the user, and/or indications of interest input by the user.

In another aspect of the method of the present invention, the computer is used to drive a process that includes powering up the computer; executing a basic input output system procedure; requesting information about and/or from a user; receiving information about and/or from the user; offering access to at least one computational functionality by the computer at least partly on the basis of the received information; and fulfilling the boot-up procedure. The offering of access to at least one computational functionality may include visually presenting an image to the user that when selected directs the computer to launch an associated software program and/or initiate a web service or a communications session.

In still another optional aspect of the method of the present invention a computer is provided that enables a user to direct the execution of one or more aspects of the method of the present invention.

In still another optional aspect of the method of the present invention a computer-readable medium is provided that when executed by a computer may cause the computer to perform one or more aspects of the method of the present invention.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

The foregoing and other objects, features and advantages will be apparent from the following description of aspects of the present invention as illustrated in the accompanying drawings.

### BRIEF DESCRIPTION OF THE FIGURES

These, and further features of the invention, may be better understood with reference to the accompanying specification and drawings depicting the preferred embodiment, in which:

FIG. 1 is a schematic diagram of a computer system by which the first method may be instantiated;

FIG. 2 is a schematic diagram presenting an electronic communications network that includes the computer system of FIG. 1;

FIG. 3 is a flow chart of the first method that may be executed by means of the electronic communications network of FIG. 2;

FIG. 4 is an entity diagram illustrating the relationships maintained among certain software modules 4.1-4.8 designed in accordance with the first method of FIG. 3 and that may be instantiated by means of the electronic communications network of FIG. 2;

FIG. 5 is a flow chart of the interactivity of the software modules of FIG. 4;

FIG. 6 is a representation of the a user interface generated in accordance with the first method of FIG. 3 and executed by means of the computer of FIG. 1 and/or the electronic communications network of FIG. 2, wherein an enclosing icon is presented in a first enclosing state;

FIG. 7 is a representation of the user interface of FIG. 6 generated in accordance with the first method of FIG. 3 and executed by means of the computer of FIG. 1 and/or the electronic communications network of FIG. 2, wherein the enclosing icon of FIG. 6 is presented in a second, or presenting, state;

FIG. 8 is an illustration of a plurality of data records used by the computer of FIG. 2 to generate a plurality of enclosing icons of FIGS. 6 and 9;

FIG. 9 is an illustration of the display screen of FIG. 1 displaying a plurality of process icons of FIG. 6;

FIG. 10 is an illustration of an optional drop down menu of the first method of FIG. 3 and that my be generated by means of the computer of FIG. 1;

FIG. 11 is a flow chart of optional steps of the first method of FIG. 3;

FIG. 12 is a flow chart of optional steps of the first method of FIG. 3 and the process of FIG. 11;

FIG. 13 is a schematic of an alternate preferred embodiment of the intelligent update client of FIG. 4;

FIG. 14 is a flowchart of an interaction of the intelligent client of FIG. 13 with the user and in accordance with certain alternate preferred embodiments of the method of the present invention;

FIG. 15 presents a toolkit data structure of a software toolkit icon that is included in certain other still additional alternate preferred embodiments of the method of the present invention;

FIG. 16 is a flowchart of an interaction of and the computer of FIG. 1 with the user, and employing the toolkit data structure of FIG. 15 in accordance with certain alternate other preferred embodiments of the method of the present invention;

FIG. 17 is an illustration of the display screen of FIG. 16 displaying a toolkit icon and a plurality of tool icons of 6;

FIG. 18 is a flowchart of a second method that is in accordance with certain yet additional preferred embodiments of the method of the present invention;

FIG. 19 is a flowchart of a boot-up process of a computer-implemented process wherein a first aspect of the method of the present invention is practiced by the computer of FIG. 1;

FIG. 20 is a flowchart of a computer-implemented process wherein a second aspect of the method of the present invention is practiced by the computer of FIG. 1 in communication with the server of FIG. 2;

FIG. 21 is an illustration of a visual presentation of a first window by the computer of FIG. 1;

FIG. 22 is a flowchart of a computer-implemented process the computer of FIG. 1 accepts information received in relation to the first window of FIG. 21;

FIG. 23 is an illustration of a presentation of a new user window by the computer of FIG. 1;

FIG. 24 is a flowchart of a computer-implemented process the computer of FIG. 1 accepts information received in relation to the new user window of FIG. 21;

FIG. 25 is an illustration of a presentation of a profile builder window by the computer of FIG. 1;

FIG. 26 is an illustration of a presentation of an interests window by the computer of FIG. 1;

FIG. 27 is an illustration of a presentation of a personality window by the computer of FIG. 1;

FIG. 28 is a schematic of a presentation a user account table maintained by the computer of FIG. 1;

FIG. 29 is a schematic of a presentation a software registry maintained by the computer of FIG. 1;

FIG. 30 is a schematic diagram illustrating certain binary data stored within an exemplary first user personality data field and a first user interests data field of a first user account table of FIG. 28;

FIG. 31 is a schematic diagram illustrating a plurality of software match binary data stored within the exemplary first personality matching data and the first interests matching data field of the exemplary first software record of FIG. 29;

FIG. 32 is a flowchart of a computer implemented process wherein an even additional aspect of the method of the present invention is practiced wherein icon data is selected for rendering by the computer of FIG. 1;

FIG. 33 is a flowchart of a computer-implemented process wherein a software program may be deleted from the computer of FIG. 1;

FIG. 34 is an illustration of the start-up desktop image as rendered by the computer of FIG. 1 in part from the plurality of application icon display data of the software records of the software registry;

FIG. 35 is an additional block diagram of the computer of FIG. 1 and showing additional aspects;

FIG. 36 is a schematic diagram of the system software of the computer of FIG. 1;

FIG. 37 is an additional block diagram of the electronics communications network of FIG. 2 showing additional software stored in the server of FIG. 2; and

FIG. 38 is a flowchart of a computer-implemented process wherein a still alternate aspect of the method of the present invention is practiced when the computer of FIG. 2 is offline and/or not in communication with the electronic communications network and/or the remote server of FIG. 2.

### DETAILED DESCRIPTION OF A PREFERRED EMBODIMENT

In describing the preferred embodiments, certain terminology will be utilized for the sake of clarity. Such terminology is intended to encompass the recited embodiment, as well as all technical equivalents, which operate in a similar manner for a similar purpose to achieve a similar result.

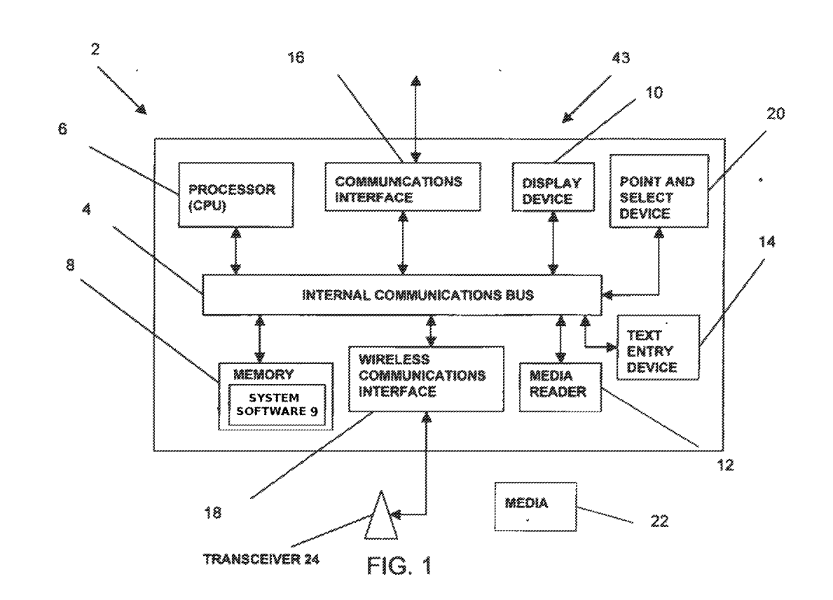

Referring now generally to the Figures and particularly to FIG. 1, FIG. 1 is a schematic diagram of a computer system 2 by which the first method may be instantiated. The computer system 2 may be may be or comprise a bundled computer software and hardware product, such as but not limited to, a.) a network-communications enabled THINKSTATION WORKSTATION™ notebook computer marketed by Lenovo, Inc. of Morrisville, N.C.; (b.) a NIVEUS 5200 computer workstation marketed by Penguin Computing of Fremont, Calif. and running a LINUX™ operating system or a UNIX™ operating system; (c.) a network-communications enabled personal computer configured for running WINDOWS XP™, VISTA™ or WINDOWS 7™ operating system marketed by Microsoft Corporation of Redmond, Wash.; (d.) a MACBOOK PRO™ personal computer as marketed by Apple, Inc. of Cupertino, Calif.; or (e.) other suitable computational system or electronic communications device known in the art capable of providing or enabling a financial web service known in the art.

The computer system 2, or computer 2, includes an internal communications bus 4 that bi-directionally couples a central processing unit 6, a system memory 8, a display device 10, a media reader 12, a text entry device 14, a network communications interface 16, and/or a wireless communications interface 18. The internal communications bus 4 additionally communicatively couples a point and select device 20 with the central processing unit 6 (hereafter “CPU” 6).

A user may communicate commands, selections and information to the computer 2 by means of the point and select device 20 and the text entry device 14. In certain other alternate preferred embodiments of the present invention the point and select device 20 may be or comprise a computer mouse such as (a.) a Targus™ Bluetooth capable computer mouse coupled with a AdapterspacerVS-AMBOIUS™ Bluetooth adapter, (b.) Apple Mighty Mouse™ computer mouse, (c.) an Apple Wireless Mouse™ computer mouse, or (d.) other suitable computer mouse or other suitable icon selection device known in the art configured to enable a user to select an icon as presented on a visual display device 10 of the computer 2. In certain still alternate preferred embodiments of the present invention the text entry device 14 may be or comprise a computer keyboard peripheral, such as an Apple Wireless Keyboard™, or other suitable keyboards known in the art and configured to enable a user to provide text input to the computer 2. In certain yet other alternate preferred embodiments of the present invention the display device 10 may be or comprise a touch screen module whereby the user may communicate commands, selections and information to the computer 2 by manually or physically pressing against a touch sensitive of a display surface of the display device 10.

The CPU 6 may include an on-chip and or and off-chip cache memory that increases the processing effectiveness of the CPU 6 in executing and running information technology processes. The media reader 12 is configured to read computer-readable and machine executable instructions stored in a computer-readable medium 22 and transmit the read instructions to the CPU 6 and the system memory 8.

The term “computer-readable medium” as used herein refers to any suitable medium known in the art that participates in providing instructions to the network for execution. Such a medium may take many forms, including but not limited to, non-volatile media, volatile media, and transmission media. Non-volatile media includes, for example, optical or magnetic disks, tapes and thumb drives. Volatile media includes dynamic memory. Transmission media 10 includes coaxial cables, copper wire and fiber optics. Transmission media can also take the form of acoustic or light waves, such as those generated during radio wave and infrared data communications. Common forms of computer-readable media include, for example, a floppy disk, a flexible disk, hard disk, magnetic tape, or any other magnetic medium, a CD-ROM, any other optical medium, RAM, a PROM, and EPROM, a FLASH-EPROM, any other memory chip or cartridge, a carrier wave as described hereinafter, or any other suitable medium known in the art from which a computer can read machine executable instructions.

Various forms of computer readable media may be involved in carrying one or more sequences of one or more instructions to the network for execution. For example, the instructions may initially be carried on a magnetic disk of a remote computer. The remote computer can load the instructions into its dynamic solid-state electronic memory 8 and send the instructions over a telephone line using a modem. A modem local to or communicatively linked with the network can receive the data on the telephone line and use an infrared transmitter to convert the data to an infrared signal. An infrared detector can receive the data carried in the infrared signal and appropriate circuitry can provide the data to the network.

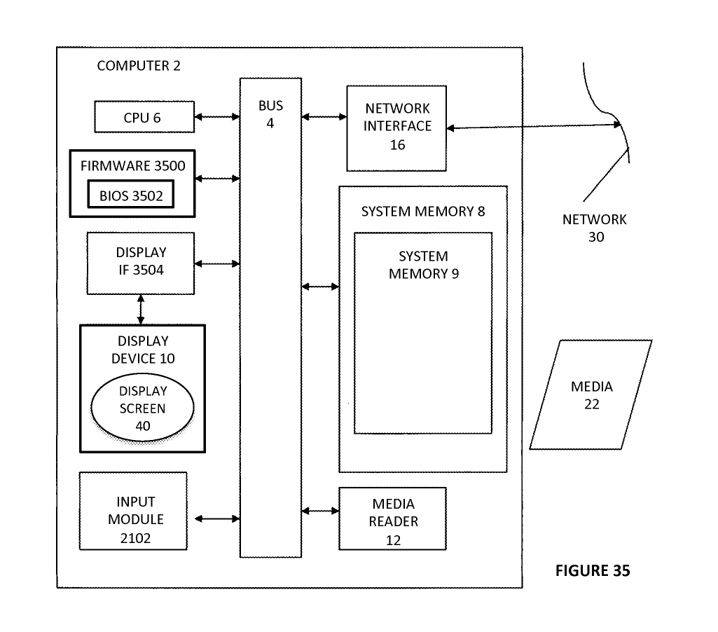

The memory 8 (hereinafter, “memory” 8) store software instructions within a system software 9 (as shown in FIG. 35) needed by the CPU 6, and the computer 2, to execute and instantiate the commands, processes and actions described herein in the flowcharts of the Figures and accompanying text, and provides these software encoded instructions via the internal communications bus 4 to the CPU 6 and generally within the computer 2. The software instructions of the system software 9 stored and provided by the memory 8 may be, comprise, or be comprised within a web based service software, an Internet service software, a web browser software, a word processor software, an address book software, a calendar software, an email client software, and a visual image presenter software. It is understood that the computer 2 may partially or fully execute or instantiate an information technology process, e.g., a software program, a web based service, and an Internet based service in accordance with a software instruction sequence that is partially stored, instantiated and/or executed outside of the computer 2. The system software 9 may include a suitable database management systems known in the art, such as but not limited to, an ORACLE DATABASE™ database management system marketed by Oracle Corporation, of Redwood City, Calif.; an MQSERIES™ database management system marketed by SyBase, Inc. of Dublin, Calif.; a Database 2™, also known as DB2™, relational database management system as marketed by IBM Corporation of Armonk, N.Y.; a Microsoft SQL Server™ relational database management system as marketed by Microsoft Corporation of Redmond, Wash.; MySQL™ as marketed by Oracle Corporation of Redwood City, Calif.; and/or a MONGODB™ as marketed by MongoDB, Inc. of New York City, USA; the POSTGRESQL™ open source object-relational database management system.

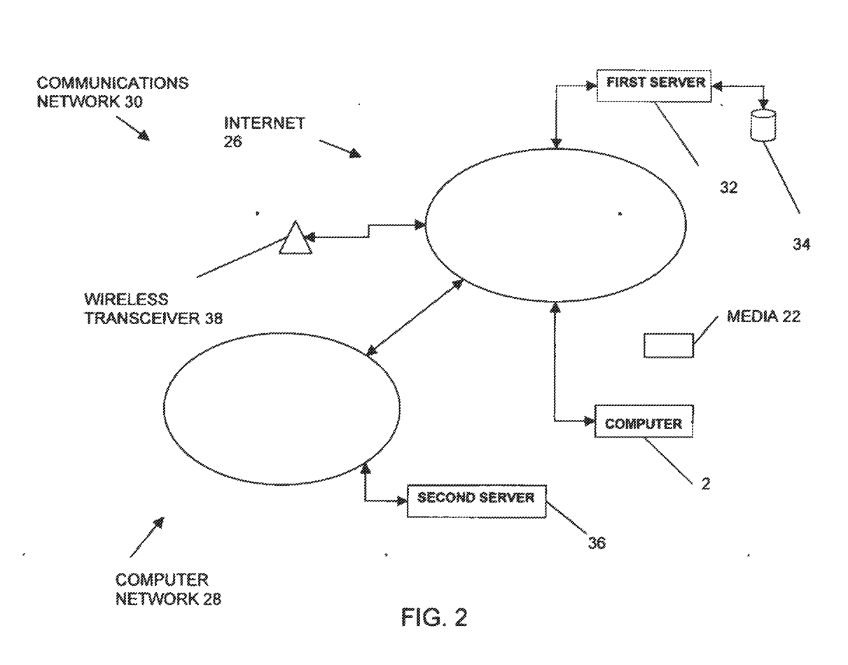

The communications interface 16 may comprise a modem configured to enable connectivity between the computer 2 and the Internet 26 (as per FIG. 2) and/or a computer network 28 (as per FIG. 2) via a landline connection of a telephony network (not shown).

The wireless communications interface 18 is paired and configured to bi-directionally communicatively couple the computer 2 to a communications network 30 via the wireless transceiver 24.

Referring now generally to the Figures and particularly to FIG. 2, FIG. 2 is a schematic diagram presenting an electronic communications network 30 that includes the computer system 2 of FIG. 1 within the Internet 26. The electronic communications network 30 may be or comprise the Internet 26, the computer network 28, a telephony network, a wireless communications network and/or other suitable electronic communications equipment and systems known in the art. A first server 32 is comprised within the Internet 26 and is configured to bi-directionally communicative with the computer 2. The computer 2 and the first server 32 are each assigned a unique and distinguishable network address in accordance with the Transmission Control Protocol and Internet Protocol. The first server 32 is configured to provide, and provides, a web service, and/or other suitable Internet service known in the art, to the computer 2. A database 34 of the first server 32 stores information related to the provided web service and may optionally enable at least partial access to this information and other information to the computer 2. The computer 2 includes a web browser and an email client that may be used to harvest and deliver information, commands and selections to the first server 32.

A second server 36 is comprised within the computer network 28 and is bi-directionally communicatively coupled with the Internet 26 (to include computer 2) by means of the computer network 28. The second server 36 is configured to provide, and provides, an information technology functionality, and/or other suitable information technology service known in the art, to the computer 2.

The second server 36 or the first server 32 may be or comprise a bundled computer software and hardware product such as, a.) a network-communications enabled THINKSTATION WORKSTATION™ notebook computer marketed by Lenovo, Inc. of Morrisville, N.C.; (b.) a NIVEUS 5200 computer workstation marketed by Penguin Computing of Fremont, Calif. and running a LINUX™ operating system or a UNIX™ operating system; (c.) a network-communications enabled personal computer configured for running WINDOWS XP™, VISTA™ or WINDOWS 7™ operating system marketed by Microsoft Corporation of Redmond, Wash.; (d.) a MACBOOK PRO™ personal computer as marketed by Apple, Inc. of Cupertino, Calif.; or (e.) other suitable computational system or electronic communications device known in the art capable of providing or enabling a financial web service known in the art.

The first server 32 and/or the second server 36 may include an ORACLE DATABASE™ database management system marketed by Oracle Corporation, of Redwood City, Calif.; an MQSERIES™ database management system marketed by SyBase, Inc. of Dublin, Calif.; a Database 2™, also known as DB2 ™, relational database management system as marketed by IBM Corporation of Armonk, N.Y.; a Microsoft SQL Server™ relational database management system as marketed by Microsoft Corporation of Redmond, Wash.; MySQL™ as marketed by Oracle Corporation of Redwood City, Calif.; and a MONGODB™ as marketed by MongoDB, Inc. of New York City, USA; the POSTGRESQL™ open source object-relational database management system; and/or other suitable database management systems known in the art.

A wireless transceiver 38 is comprised within the Internet 26 and is configured, tuned and paired to enable bi-directional communications between the computer 2 and the first server 32 and the second server 36 by means of the electronic communications network 30 and the transceiver 24 and the wireless communications interface 18.

In certain alternate preferred embodiments of the method of the present invention, the computer 2 may be an isolated computational system, having no communicative coupling with either any electronic communications network 26 28 & 30 nor any other computational devices 32 & 36.

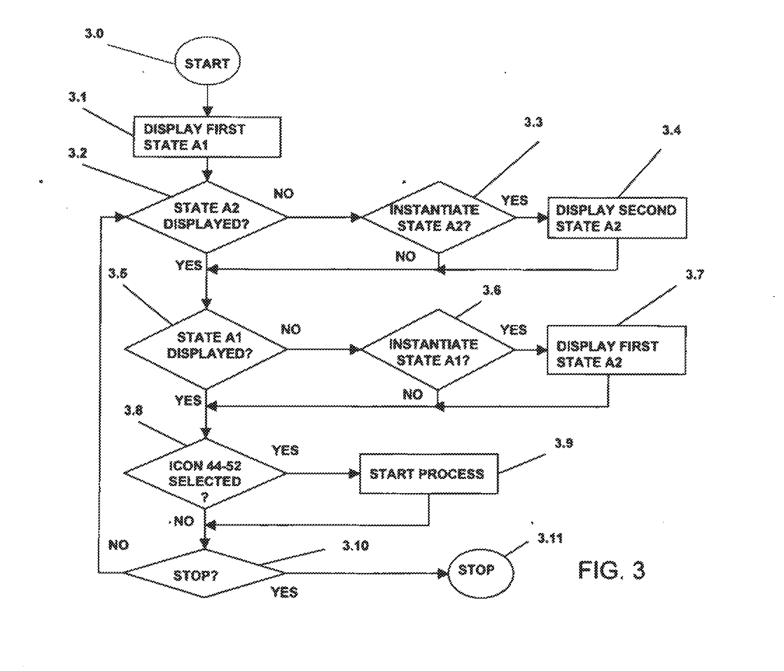

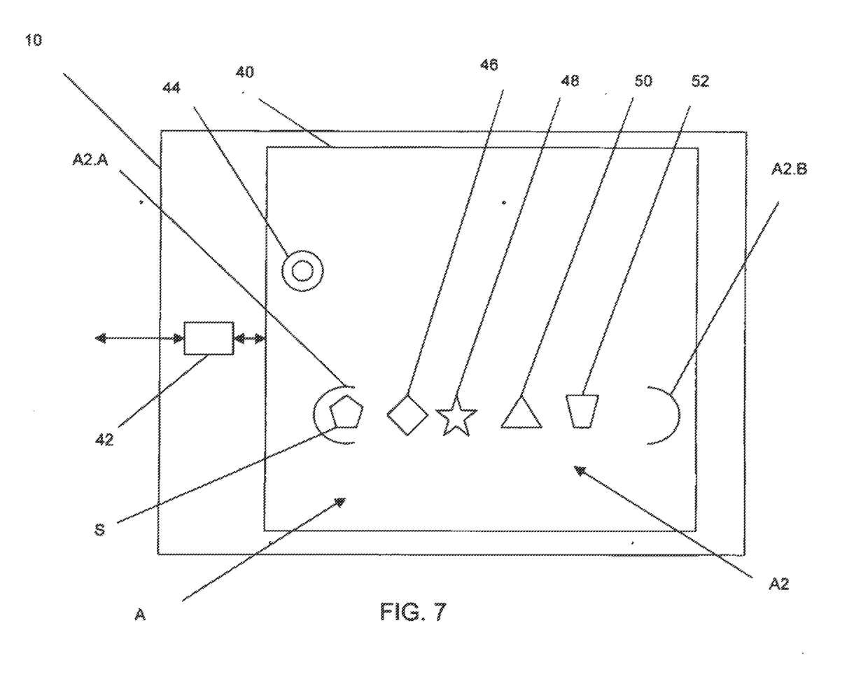

Referring now generally to the Figures and particularly to FIGS. 3, 6, 7, FIG. 6 illustrates an enclosing icon A shown in an enclosing state A1, whereas FIG. 7 illustrates the enclosing icon in a presenting state A2. FIG. 3 is a flow chart of the first method, wherein the enclosing icon A alternates between the enclosing state A1 and the presenting state A2, that may be executed by means of the electronic communications network 30 of Figure In step 3.0 the computer 2 is powered up. In step 3.1 the computer 2 renders the enclosing icon A in the first enclosing state A1. In the loop 3.2-3.4 the computer 2 determines whether the enclosing icon A shall be rendered in the presenting state A2. In loop 3.5-3.7 computer 2 determines whether the enclosing icon A shall be rendered in the enclosing state A1. In step 3.8 the computer 2 determines whether a process icon 44-52 (see FIG. 7) has been selected by the user by means of the point and select device 20. It is understood that the computer 2 may be presenting the icon A in the enclosing state A1, with no process icons 44-52 presented, when the computer executes step 3.8; in these instances of the first method the computer 2 proceeds from step 3.8 onto step 3.10. When the computer 2 determines in step 3.8 that a process icon 44-52 has been selected by the user, the computer 2 proceeds on in step 3.9 to initiate the execution, or a session of, an information technology process associated with the process icon 44-52 determined in step 3.8 to have been selected. In step 3.10 the computer 2 determines whether the computer 2 shall continue to determine whether the enclosing icon A shall be maintained as rendered in a current state A1 or A2, or alternatively rendered in an alternate state A1 or A2.

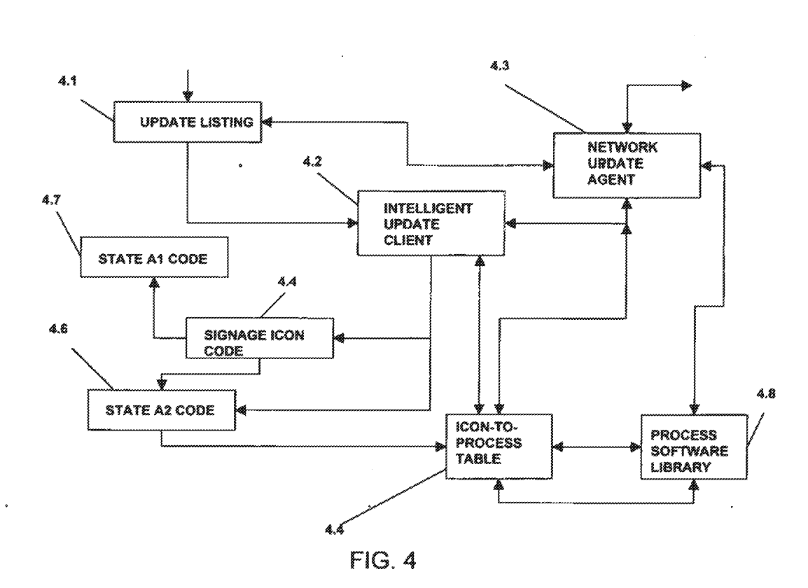

Referring now generally to the Figures and particularly to FIG. 4, FIG. 4 is an entity diagram illustrating the relationships maintained among certain software modules 4.1-4.8 stored within the computer 2 and designed in accordance with the first method of FIG. 3, and that may be instantiated by means of the electronic communications network of FIG. 2. An update listing module 4.1 receives and stores information originated from a computer-readable electronic media 22 (hereinafter, “media” 22), the communications network 30, the text entry device 14, and/or the point and select device 20 that is to be integrated into the process of the first method. An intelligent update client 4.2 receives information from the update listing module 4.1 and provides update information to a network update module 4.3, an icon-to-process table 4.4, to a signage icon software 4.5, and/or to a second state A2 code 4.6 of the enclosing icon A. Examples of update information might include personalized information that is added to the signage icon software 4.5, or the introduction of a new process icon 44-52 into the presenting state A2 software code.

The network update software agent 4.3 is configured to inform other elements of the communications network 30, e.g., the first server 32 and the second server 36, of information received by the update listing software module 4.1.

The second present state A2 code 4.6 comprises machine readable software encoded instructions that enable the computer 2 to render the second presenting state A2 of the enclosing icon A, whereas a first enclosing state A1 code 4.7 comprises machine readable software encoded instructions that enable the computer 2 to render the first enclosing state A1 of the enclosing icon A. A process software library 4.8 includes a plurality of computer-readable instruction sets, e.g., software programs, that enable the computer 2 to initiate an information technology process associated with each process icon 44-52. The icon-to-process table 4.4 associates each process icon 44-52 with at least one of the computer-readable instruction sets that may be used by the computer 2 to execute, run, request, or initiate a session of an information technology process.

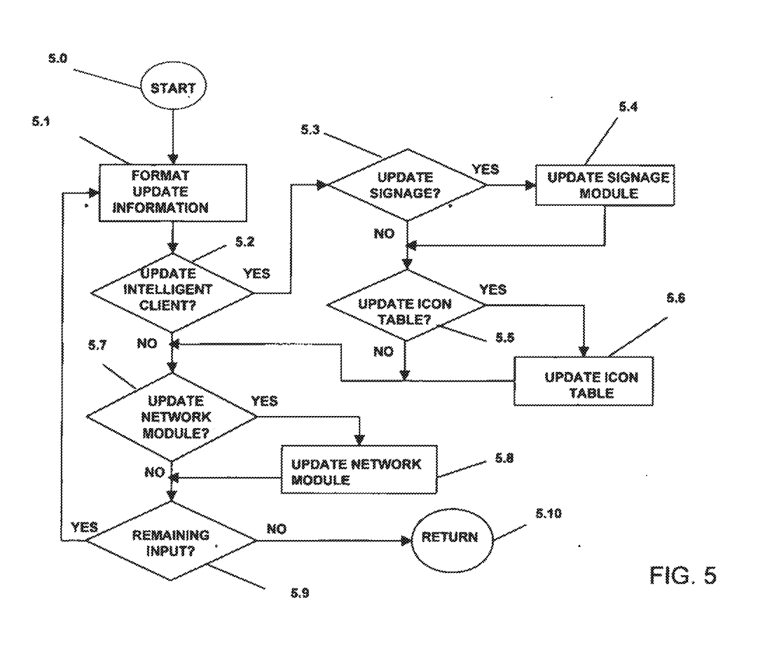

Referring now generally to the Figures and particularly to FIG. 5, FIG. 5 is a flow chart of the interactivity of the software modules 4.1-4.8 of FIG. 4. In step 5.0 information is received by the update listing module 4.1. In step 5.1 the information received in step 5.0 is formatted for use by one or more of the entities 4.1-4.8. In step 5.2 the computer 2 determines whether any of the information formatted in step 5.1 shall be integrated by the intelligent update client 4.2. In step 5.3 the computer 2 determines whether any information received by the intelligent update client 4.2 shall be used by or integrated into, the signage icon module 4.5, and in step 5.4 information is used by or integrated into the signage icon module 4.5, whereby the rendering of the signage S within the user interface UI may be affected.

In step 5.5 the computer 2 determines whether any information received by the intelligent update client 4.2 shall be used by, or integrated into, the icon-to-process table 4.4, and in step 5.6 information is used by integrated into the icon-to-process table 4.4, whereby the association of one or more process icons 44-52 with one or more computer-readable instruction sets of the process software library 4.8 may be affected.

In step 5.7 the computer 2 determines whether any information received by the intelligent update client 4.2 shall be used by, or integrated into, the network update software agent 4.3, and in step 5.8 information is used by, or integrated into, the intelligent update client 4.2, whereby the interactivity of the computer 2 and the electronics communications network 30 may be affected.

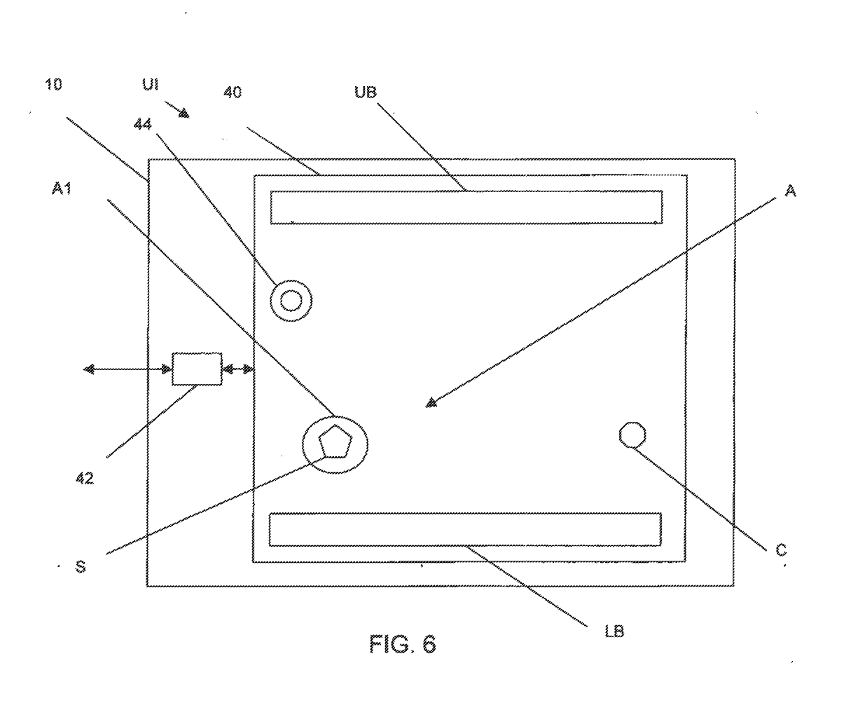

Referring now generally to the Figures and particularly to FIG. 6, FIG. 6 is a representation of a graphical user interface UI generated in accordance with the first method of FIG. 3 and executed by means of the electronic communications network 30 of FIG. 2, wherein an enclosing icon A is presented in a first enclosing state A1. The display device 10 includes a display screen 40 and a display logic 42, or display interface circuit 42. The display interface circuit 42 is communicatively coupled with the internal communications bus 4 of the computer 2 and provides information received from the computer 2 and to the display screen 40 to enable the display screen 40 to visually present the user interface UI. Where the display screen 40 is a touch screen, the display interface circuit 42 accepts pressure sensing information from the display screen 40 and provides the received pressure sensing information to the internal communications bus 4 for evaluation and computation by the CPU 6.

Referring now generally to the Figures and particularly to FIGS. 1, 5, 6 and 7, the CPU 6, the memory 8, the internal communications bus 4, and the display device 10 are comprised within a system logic 43, the system logic 43 configured to visually present icons 44-52 (as per FIG. 7) associated with unique software programs stored within, or accessible by, the computer 2.

Referring now generally to the Figures, and particularly to FIGS. 6 and 7, the cursor C is positioned in accordance with positioning and movement information transmitted from the point and select device 20 via the internal communications interface 4 and to the display device 10, optionally in accordance with commands or additional information provided by the CPU 6 to the display device 10. When the cursor C is positioned over the enclosing icon A in the first enclosing state A1 and a select command is generated by the user via the point and select device 20, e.g., by depressing a button on a computer mouse of the point and select device 20, the computer 2 will direct the display device 10 to cease visually presenting the enclosing icon A in the first enclosing state A1, and to initiate displaying the enclosing icon A in a second state A2, or present state A2, as discussed below in reference to FIG. 7.

An information technology process icon 44, or process icon 44, is also provided by the computer 2 and within the user interface UI. An information technology process related to the process icon 44 is initiated, executed or run when the user selects the process icon 44 by placing the cursor C over the process icon 44 and depressing, clicking, or double clicking, a select feature, such as a select button, on the point and select device 10. Where the point and select device 20 is or comprises a computer mouse, the user shifts the position of the cursor C within the user interface UI by manipulating the computer mouse along a substantively planar two dimensional surface, e.g., a mouse pad.

An upper band UB and a lower band LB of the user interface UI may further comprise or present a plurality of process icons 44, each process icon 44 associated with a unique information technology process, such as a software program, a web based service, and/or an Internet based service.

Software enabling the functionality of the enclosing icon A as described herein may be stored within the computer 2 and/or made available to the computer 2 by means of the electronic communications network 30. In the first enclosing state A1 a signage S is visually presented with the enclosing icon A. The signage S may be associated with an entity, such as a corporation. The term “corporation” is defined herein to include a person, a partnership, an association of persons or corporations, a team, a sports team, a political party, an ethnicity, a nation, a legally recognized corporation, and/or an idea.

Referring now generally to the Figures and particularly to FIG. 7, FIG. 7 is a representation of the user interface UI of FIG. 6 generated in accordance with the first method of FIG. 3 and executed by means of the electronic communications network 30 of FIG. 2, wherein the enclosing icon A is presented in a second state A2 (hereafter “presenting state” A2). The presenting state A2 visually presents the signage S, a first shell half A2.A, a plurality of process icons 46-52, and a second shell half A2.B.

The shell halves A2.A & A2.B provide a visual context to the paradigm that the enclosing icon A provides a location in the user interface UI where plurality of presented process icons 46-52 reside or can be easily located. The user may direct the computer 2 to change the state of the enclosing icon A from the presenting state A2 to the enclosing state A1 by manipulating the point and select device 10 to position the cursor C over the signage S or either shall half A2.A & A2.B and actuating a select feature on the point and select device 10, e.g., by clicking a mouse button.

Alternatively, the user may direct the computer 2 to initiate an information technology process associated with any one of the plurality of the presented process icons 46-52 by manipulating the point and select device 10 to position the cursor C over a selected presented process icon 46-52 and then actuating a select feature on the point and select device 10.

A first presented process icon 46 is associated with a first information technology process, where the first information technology process is instantiated by a first software program that is stored within the computer 2. User selection of the first process icon 46 directs the computer 2 to launch the associated first software program and make the first information technology process available to the user. Examples of functionalities that might be provided by the first information technology process include a word processor program, an electronic calendar program, a database, an educational program, and a game program.

A second presented process icon 48 is associated with a second information technology process, where the second information technology process is instantiated by a second software program that is stored partially within the computer 2 and partially within the first server 32. User selection of the second process icon 48 directs the computer 2 to launch, or initiate an execution or a session, of the associated second software program. Examples of functionalities that might be provided by the second information technology process include a network distributed game suite, a web-based email client and server pair, or a calendar accessible for updating by multiple parties.

A third presented process icon 50 is associated with a third information technology process, where the third information technology process is instantiated by a third software program that is stored partially within the computer 2 and partially within the media 22. User selection of the third presented process icon 50 directs the computer 2 to launch, or initiate an execution or a session, of the associated third software program. Examples of functionalities that might be provided by the third information technology process include an applications process that requires information readable from the media 22, such as a database, an encryption key, an account designator, a user identification, a password, and/or a permission.

A fourth presented process icon 52 is associated with a fourth information technology process, where the fourth information technology process is instantiated by a web browser software program that is stored wholly within the computer 2. User selection of the fourth presented process icon 52 directs the computer 2 to launch, or initiate an execution or a session, the web browser software program.

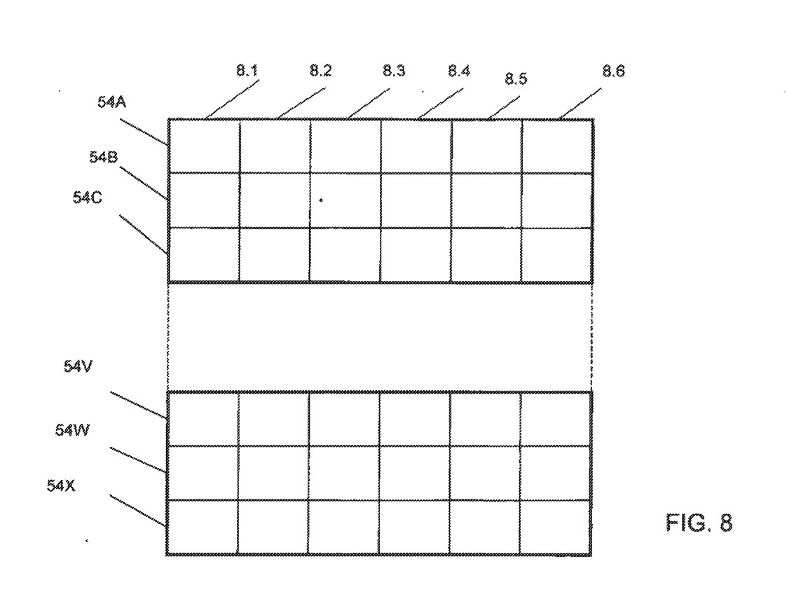

Referring now generally to the Figures and particularly to FIG. 8, FIG. 8 is a schematic diagram of a plurality of enclosing icon data records 54A-54X, wherein each enclosing icon data record 54A-54X includes information useful to the computer 2 in instantiating one or more enclosing icons A-X. The plurality of enclosing icon data records 54A-54X may be stored in the memory 8 of the computer system 2. Each enclosing data record 54A-54X includes an identification data field 8.1, a name data field 8.2, a visual image data field 8.3, a password data field 8.4, a process icon data field 8.5, and a user profile data field 8.6. The identification data field 8.1 contains a unique identifier of the instant enclosing icon data record 54A-54X. The remaining enclosing icon data fields 8.2-8.6 contain data that is associated with a single enclosing icon A-X associated with the unique identifier of the identification data field 8.1, wherein each enclosing data record 54A-54X is separately associated in a one-to-one correspondence with a single enclosing icon A-X. The name data field 8.2 contains a name associated with the enclosing icon data record 54A-54X that is associated with the identifier of the identification data field 8.1 of the same enclosing data record 54A-54X, wherein the name may be visually presented on the display screen 40 of the computer system 2. The visual image data field 8.3 contains data used by the computer to display the enclosing icon A-X that is associated with the instant enclosing icon data record 54A-54X, to include two or more states of the enclosing icon A-X. The password data field 8.4 includes a password that may be necessary for a user to provide in order to execute the associated enclosing icon A-X. The process icon data field 8.5 contains data used by the computer system 2 to display one or more process icons 44-52 that are associated with the instant enclosing icon data record 54A-54X. The user profile data field 8.6 contains information related to one or more users of the computer system 2, such as credit card account information, or authorization to use processes or services of the computer system 2.

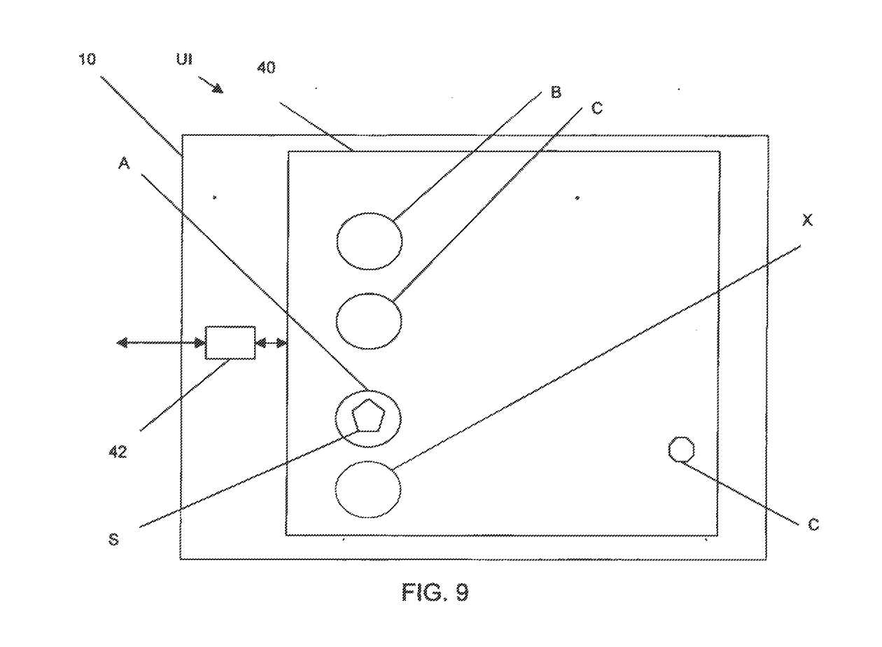

Referring now generally to the Figures and particularly to FIG. 9, FIG. 9 is an illustration of the display screen 40 showing a plurality of enclosing icons A-X, wherein each enclosing icon A-X may present in the enclosing state A1 or the presenting state A2. One or more users may use the point and select device 20 to direct the computer system 2 to display each icon A-X in either state A1 or A2. The enclosing icons A, B, C & X are illustrated in FIG. 9 in the enclosing state A1, and it is understood that each enclosing icon record 54A-54X enables the computer system 2 to display the associated enclosing icon A-X in either the enclosing state A1 or the presenting state A2, and with a unique or and personalized signage S presented in either or both states A1 & A2.

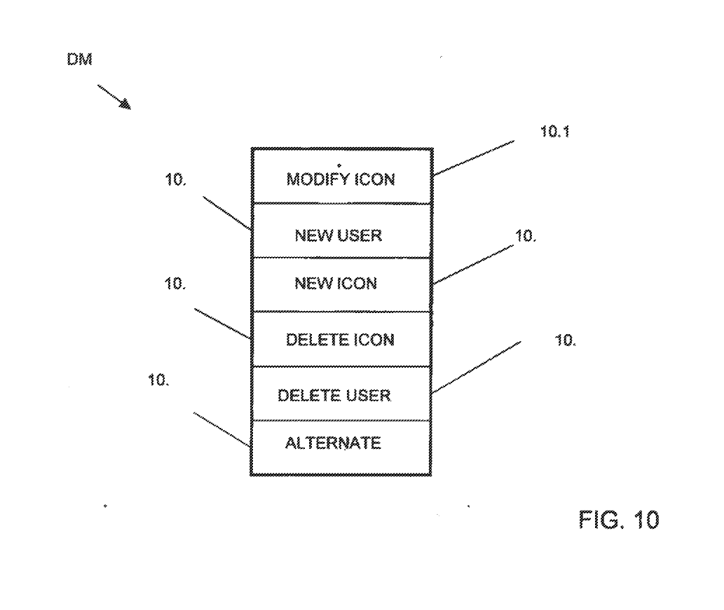

Referring now generally to the Figures and particularly to FIG. 10, FIG. 10 is an illustration of a drop down menu DM that may be presented on the display screen 20 upon a command issued by the user by means of the point and select device 20. In one embodiment, the user may use the point and select device to place the cursor C over the first enclosing icon A, or optionally any icon A-X, and then double-click a select button of the point and select button 20 to direct the computer system 20 to display the drop down menu DM. The user may then select a function 10.1-10.5 of the means of manipulating the point and select device 20 and a select feature of the point and select device 20. A first function 10.1 enables the user to edit and modify data stored or associated with an existing enclosing icon data record 54A-54X. A second function 10.2 enables the user to add a new user to be authorized to use an existing enclosing icon data record 54A-54X. A third function 8.3 enables the user to create a new enclosing icon data record 54A-54X for use by the computer 2 in generating an additional enclosing icon A-X.

A fourth function 8.4 enables the user to direct the computer system 2 to delete an existing icon data record 54A-54X. A fifth function enables the user to delete a user from an existing enclosing icon data record 54A-54X, whereby an identified user may lose authorization by the computer system 2 to control the functionality of an icon A-X associated with an associated enclosing icon data record 54A-54X. A sixth functionality 10.6 is presented to clarify that the drop down menu DM may include additional suitable functionalities known in the art.

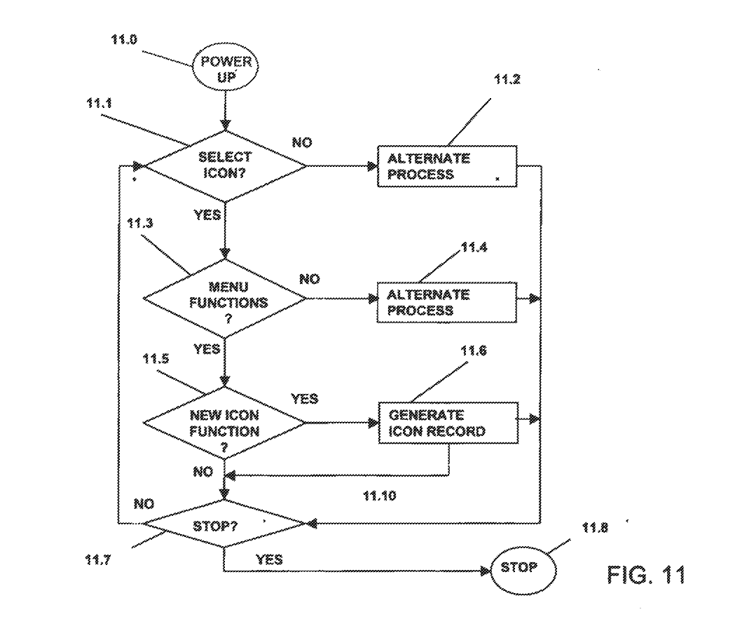

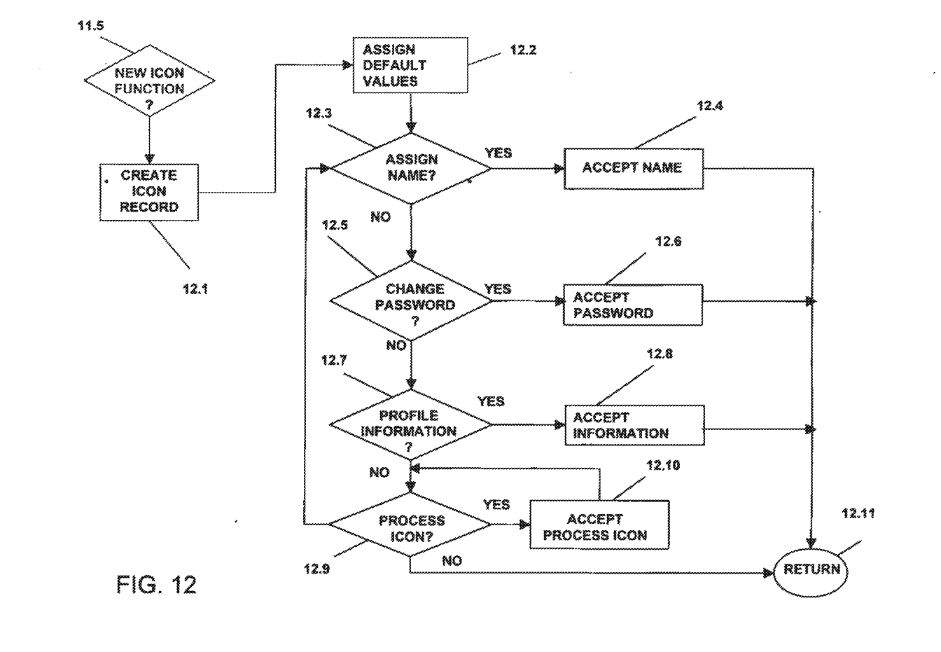

Referring now generally to the Figures and particularly to FIG. 11, FIG. 11 is a flow chart of optional steps of the first method, wherein the computer system 2 may be directed by the user to create or modify an existing enclosing icon data record 54A-54X. In step 11.0 the computer system 2 is powered up and the computer system 2 consequently boots up and displays enclosing icons A-X. In step 11.1 the computer system 2 determines whether the user has selected an enclosing icon A-X by means of the point and select device 20. In step 11.2 the computer system 2 may execute an alternate process. In step 11.3 the computer system 2 determines whether the user has directed the computer system 2 by means of the point and click device 20 to display the icon drop down menu DM. In step 11.4 the computer system may proceed on to execute an alternate process. In step 11.5 the computer system 2 may execute an alternate process. In step 11.3 the computer system 2 determines whether the user has directed the computer system 2 by means of the point and click device 20 to enable the third function 10.3 of the drop down menu DM, whereby a new enclosing icon data record 54A-54X may be generated. In step 11.6 the computer interacts with the user to generate a new enclosing data record 54A-54X, as per FIG. 12. In step 11.7 the computer system determines whether to proceed back to step 11.1 or to power down in step 11.8.

Referring now generally to the Figures and particularly to FIG. 12, FIG. 12 is a flow chart of optional steps of the first method of FIG. 6 and optional steps of FIG. 11, wherein the computer system 2 may be directed by the user to create or modify an existing enclosing icon data record 54A-54X. Steps 12.1 through 12.11 may optionally be included within the step 11.6 of the software process described in FIG. 11. The computer 2 may, as directed by the user, move from step 11.5 to step 12.1, wherein a new enclosing data record 54A-54X is generated by the computers system 2. In step 12.2 the computer system 2 may fill the data fields 8.1-8.6 of the new enclosing icon data record 54A-54X. In step 12.3 the computer system 2 determines whether the user is inputting a name to be associated with the new enclosing icon data record 54A-54X. In step 12.4 the computer system 2 writes the name information received from the user into the name data field 8.2 of the new enclosing icon data record.

In step 12.5 the computer system 2 determines whether the user is inputting a password to be associated with the new enclosing icon data record 54A-54X. In step 12.6 the computer system 2 writes the name information received from the user into the password data field 8.4 of the new enclosing icon data record 54A-54X.

In step 12.7 the computer system 2 determines whether the user is inputting other information to be associated with the new enclosing icon data record 54A-54X. In step 12.8 the computer system 2 writes the name information received from the user into the visual data field 8.3 and/or the profile data field 8.6 of the new enclosing icon data record 54A-54X. Information provided by the user and written into the visual data field 8.3 in step 12.8 may include image information that is displayed in the first enclosing state A1 and/or the second presenting state A2 of the instant and associated enclosing icon A-X. In addition, information provided by the user and written into the profile data field 8.6 in step 12.8 may include image information that is displayed in the first enclosing state A1 and/or the second presenting state A2 of the instant and associated enclosing icon A-X.

In step 12.9 the computer system 2 determines whether the user is directing the computer system 2 to include process icon identifiers, and optionally, other information related to selected process icons 44-52. In step 12.10 the computer system 2 writes information into process icon data field 8.5 of the new enclosing icon data record 54A-54X, wherein the information written into the process icon data field is accessed by the computer system 2 to display one or more associated process icons 44-52 when the enclosing icon A-X identified by information contained within the identification field 8.1 of the instant enclosing icon data record 54A-54X is in the presenting state A2.

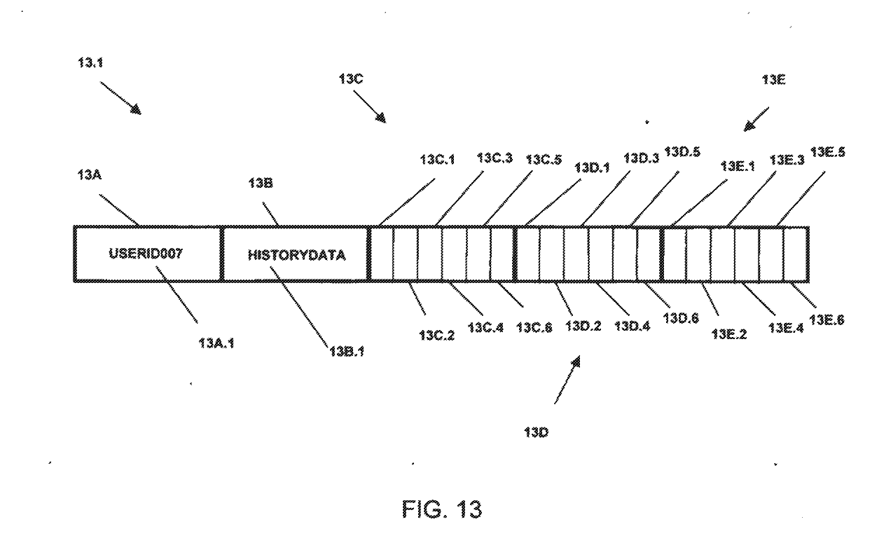

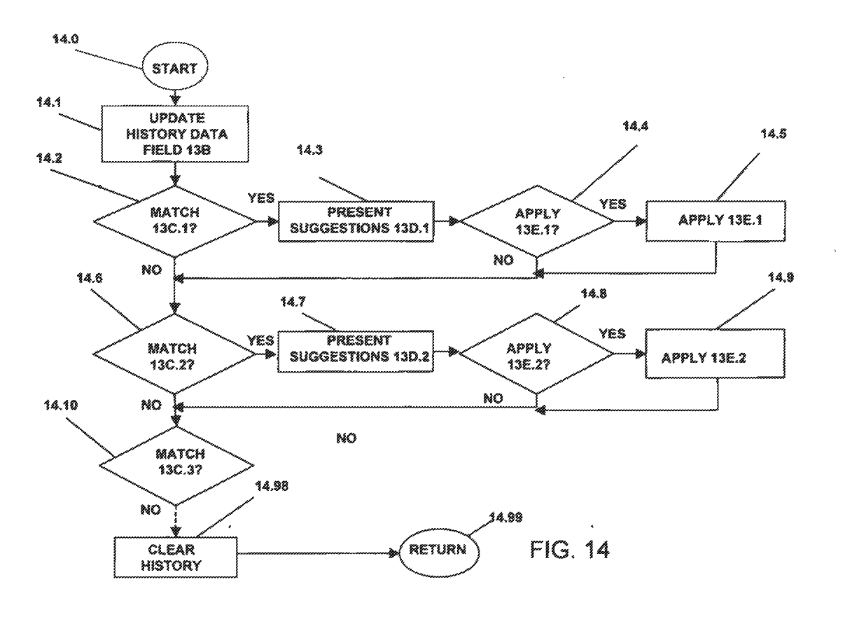

Referring now generally to the Figures and particularly to FIG. 13, FIG. 13 is a schematic of a data structure names a user behavior record 13.1 of the intelligent update client 4.2 of FIG. 4. The intelligent update client 4.2, or intelligent client 4.2, uses the user behavior record 13.1 to maintain a-record of user interaction with the computer 2, to present suggestions to the user for modification of the associated enclosing icon data record to the user, to present suggestions to the user for modification of the operations of the computer 2, and to enable the application of suggestions as directed by the user. A client ID field 13A containers a user identifier 13A.1 that identifies a registered user associated with each separate user behavior record 13.1, and is used by the computer to assign an individual user record 13.1 to a specific enclosing icon data record 54A-54X in a one-to-one unique correspondence. A history field 13B stores history records 13B.1 of the user's activity with the computer 2. A behavior signature field 13C includes a plurality of behavior patterns 13C.1-13C.6 against which the interaction history of the user stored in the history filed 13B are occasionally compared; where a match is found between the history stored in the history field 13B and one or more behavior patterns 13C.1-13C.6, the intelligent client will query the user via the display device 10 whether to make a modification to the content of the enclosing icon data record 54A-54X associated with the instant user record 13.1, as described below in reference to FIG. 14. A query logic data field 13D comprise query instructions 13D.1-13D.6 that direct the computer 2 to present suggestions to the user for modifications to an enclosing icon record 54A-54X and other aspects of the computer 2 and to accept and interpret user responses to the presented queries. A modification logic data field 13E comprise modification instructions 13E.1-13E.6 that direct the computer 2 to implement the user responses to the suggestions as interpreted by the query instructions 13D.1-13D.6 of the query logic data field 13D.

Referring now generally to the Figures and particularly to FIGS. 13 and 14, FIG. 14 is a flowchart of an interaction of the intelligent client 4.2 with the user that is comprised within certain other still additional alternate preferred embodiments of the method of the present invention. In step 14.1 the intelligent client 4.2 updates the history data field 13B of the user data record 13.1 associated with an individual enclosing data record 54A-54X. In step 14.2 the intelligent client 4.2 compares the informational contents of the history data field 13B with information stored in a first behavior signature data field 13C.1, whereby the computer 2 determines whether each individual process icon 44-52 referenced in the enclosing data record 54A-54X has been selected by the user within a certain period of time. For example, if the comparison of step 14.2 might determine whether the user has not selected a particular process icon presented by the enclosing icon A in the presenting state A2 within 30 days. The intelligent client 4.2 may then query the user in step 14.3 in accordance with a first query instructions 13D.1 whether that particular process icon 44-52 shall be deleted from the enclosing data record 54A-54X. Upon user direction as interpreted in step 14.4 and in accordance with the first query instructions 13D.1, the computer 2 deletes the process icon 44-52 from the enclosing data record 54A-54X in step 14.5 and in accordance with a first modification instructions 13E.1.

The computer then proceeds from steps 14.2, 14.3, 14.4 or 14.5 to step 14.6, wherein the computer 2 compares the informational contents of the history data field 13B with information stored in a second behavior signature data field 13C.2, whereby, for example, the computer 2 might determine whether an individual process icon 44-52 not referenced in the enclosing data record 54A-54X has been selected by the user repeatedly within a certain period of time. For example, if the user has selected a particular process icon 44-52, and one that is not presented by the enclosing icon A in the presenting state A2, more than ten times within the previous 48 hours, the intelligent client may the user in step 14.7 in accordance with a second query instructions 13D.2 whether that particular process icon 44-52 shall be added to the enclosing data record 54A-54X. Upon user direction as received and interpreted in step 13E.2 and in accordance with the second query instructions 13D.2, the computer 2 adds a reference to the frequently selected process icon 44-52 from the enclosing data record 54A-54X associated with the user ID 13A.1 in step 14.9 and in accordance with a second modification instructions 13E.2.

Computer 2 compares the informational contents of the history data field 13B with the information stored in a third through sixth behavior signature data fields 13C.3-13C.6 in executing steps 14.10 through 14.97, whereupon in step 14.98 the information stored in the history data field 13B that is aged later than a set time period, exemplary aged time periods including one hour, two days or six weeks, is deleted to free up writeable memory capacity in the history data field 13B. In step 14.99 the computer 2 return to performing other computational operations.

It is understood that the behavior signature data fields 13.1-13.6 may alternatively include suitable algorithms known in the art to compare user interaction with the computer 2 and or communications network 30. For example, an algorithm at least partially stored in a behavior signature data field 13C.1-13C.6 may be implemented by the intelligent client 4.2 to direct the computer 2 to suggest to the user that a certain process icon 44-52 be presented in the enclosing icon's A presenting state when an appropriate pattern of interaction is detected by the computer 2. In another example, the intelligent client 4.2 may direct the computer 2 to suggest an alternate web browser, or an updated version of a web browser. In another example, the intelligent client 4.2 may suggest a downloading from the communications network 30 of an update to a word processor software program, e.g. Microsoft's WORD™ word processing program. The intelligent client may alternatively or additionally suggest an uploading of a new software program, or an update of a software program, from the media 22 by means of the electronic media reader 12, in response to the analysis of the informational content of the history data field 13B by application of an algorithm at least partially stored in a behavior signature data field 13C.1-13C.6. In another example, the computer 2 may suggest an acceptance of a process icon 44-52 related to a web service as directed by the intelligent client 4.2.

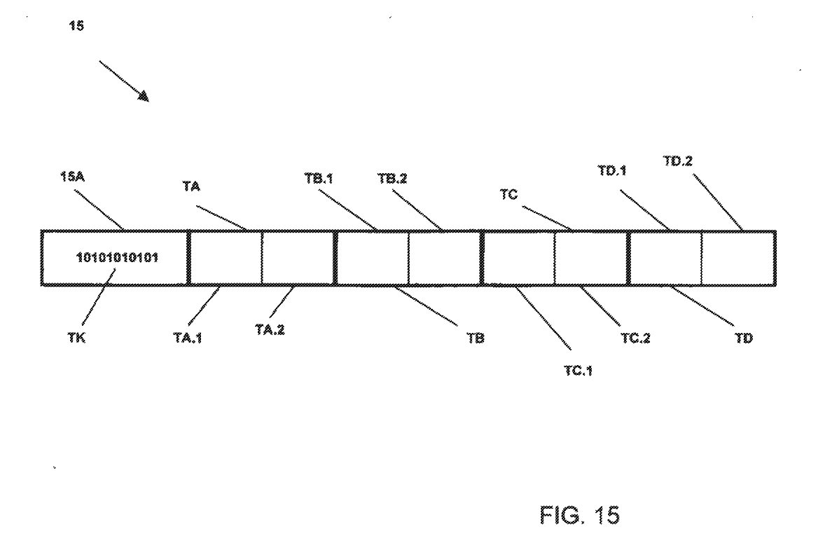

Referring now generally to the Figures and particularly to FIGS. 7, 15 and 16, FIG. 15 presents a toolkit data structure 15 of a software toolkit icon T that is included in certain still additional alternate preferred embodiments of the method of the present invention. The toolkit data structure 15 includes (1.) a toolkit identification data field 15A containing a toolkit icon information TK, and (2.) a plurality of tool data fields TA-TD. Each tool data field TA-TD is uniquely associated with an information technology process, such as a web service or a software utility program. Machine-readable instructions that enable the computer 2 to launch, execute, initiate or run the related information technology process may be at least partially stored within the computer 2, or made available in whole or in part to the computer 2 via the communications network 30 or the media reader 12. Each tool data field TA-TD includes a tool icon data TA.1-TD.1 and a tool ID data TA.2-TD.2. Each tool icon data TA.1-TD.1 includes information that enables the computer to present an associated tool icon T1-T4 that is visually associable by the user with a software utility. Each tool icon T1-T4 is associated with a unique software program that is executable by reference to the tool ID data TA.2-TD.2 stored in the tool data field TA-TE of the toolkit data structure 15.

The toolkit icon information TK enables the computer 2 to visually present an icon T visually associable by the user with the function of providing access to a plurality of software utilities.

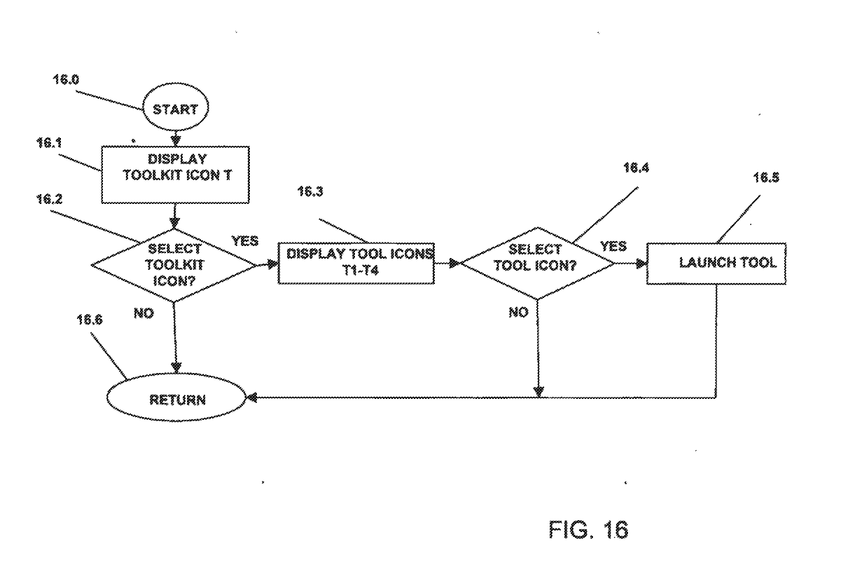

In practice, and as described now in particular reference to FIG. 16, the toolkit icon T is displayed in step 16.1 wherein the enclosing icon A is displayed in the presenting state A2. In step 16.2 the toolkit icon T may be selected and in step 16.3 the toolkit icon T is placed in a presenting state T.2 and the tool icons T1-T6 are displayed by the display screen 40. In step 16.4 a tool icon T1-T6 may be selected and in step 16.5 a utility software program, web service, or other suitable information technology process known in the art and associated with a tool icon T1-T6 selected in step 16.4 is launched, instantiated, initiated or otherwise run or initiated.

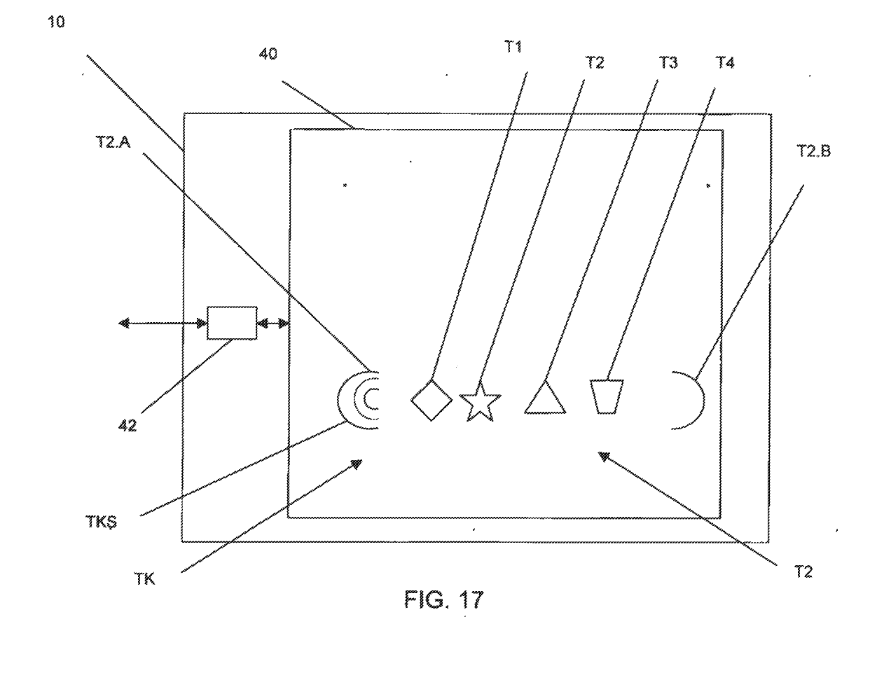

Referring now generally to the Figures and particularly to FIG. 17, the toolkit icon TK is displayed in a presenting state T2, and displaying state icons elements T2.A and T2.B and toll icons T1, T2, T3 & T4. A toolkit signage TKS visually identifies the presenting state T2 as an aspect of the toolkit TK to the user. The information stored in the toolkit data structure enables the computer 2 to generate the toolkit TK in both an enclosing state, a presenting state T2, as well as the tool icons T1-T4 and the toolkit signage TKS on the display screen 40.

Information technology processes that may be made available to the user by means of the toolkit icon T and the toolkit data structure 15 may provide one or more of the functions of (a.) desktop cleanup, (b.) clearing of historical records of web browsers and other software programs, (c.) clearing temporary files and documents, (d.) defragging operations of en electronic, magnetic or optical disk device.

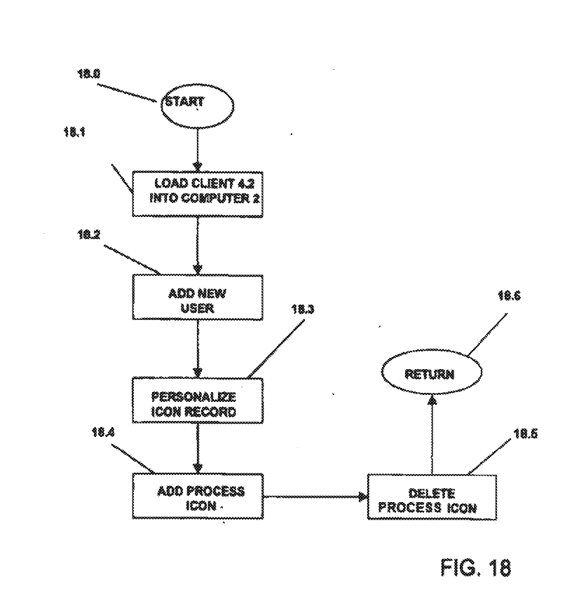

Referring now generally to the Figures and particularly to FIG. 18, a yet additional preferred embodiment of the method of the present invention, or second method, is described. It is understood that one or more steps of the second method may be included with one or more steps or aspects of the first method in other various alternate preferred embodiments of the method of the present invention. In step 18.1 the intelligent client 4.2 is provided to the computer 2 by downloading from the communications network 30 or alternatively by uploading from the electronic media 22. In step 18.2 a new user is added and a new user icon record 54A-54X is generated. In step 18.3 personalized information, such as music data, passwords and shortcuts to selected information technology tools is added to a user icon record 54A-54X. In step 18.4 a process icon 44-52 may be newly associated with a selected enclosing icon A by selecting the enclosing icon A, placing the selected enclosing icon A into a presenting state A2, and dragging a process icon 44-52 onto the enclosing icon A and dropping the selected process icon 44-52 while the cursor C is over the enclosing icon A. In step 18.5 a process icon 44-52 may be deleted from an icon record 54A-54X by placing the enclosing icon into the presenting state A2, selecting the process icon 44-52 from enclosing icon A, dragging the selected process icon 44-52 away from the enclosing icon A and then dropping the selected process icon 44-52 while the cursor C is distal from the enclosing icon A.

Various operations of selecting, dragging and dropping enclosing icons A, process icons 44-52 and tool icons T, T1-T6, are enabled in certain various preferred alternate embodiments of the method of the present invention by manipulation the point and select device 20 that is coupled with or comprised within comprised within the computer 2.

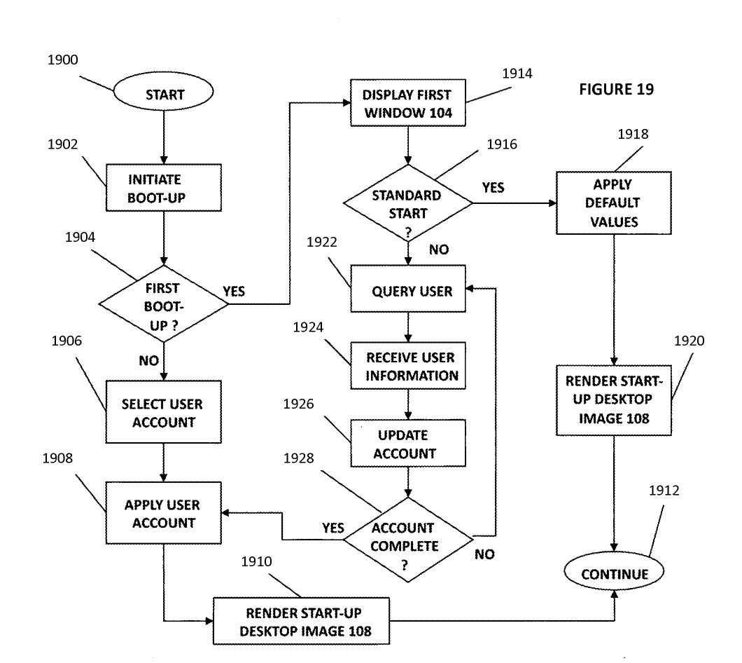

Referring now generally to the Figures and particularly to FIG. 19, FIG. 19 is a flowchart of a computer implemented process wherein a first aspect of the method of the present invention is practiced. In step 1900 a computer 2 receives a boot-up command and electrical power is provided to the computer 2. In step 1902 a boot-up process of the computer 2. In step 1904 the computer 2 determines whether the current boot-up process is part of a first boot-up process of an out-of-the-box experience of a new user of the computer 2. When the computer 2 determines in step 1904 that the computer 2 is not performing a first boot-up, the computer 2 proceeds form step 1904 to step 1906 and to select an exemplary user account record 112.A (or “user account” 112.A) from a plurality of existing user accounts 112.A-112.N and apply the selected user account records 112.A-112.N (or “user accounts” 112.A-112.N) in step 1908 to render a start-up desktop image 108 in step 1910. The computer 2 proceeds from step 1910 to step 1912 and to perform additional computational processes in step 1912.

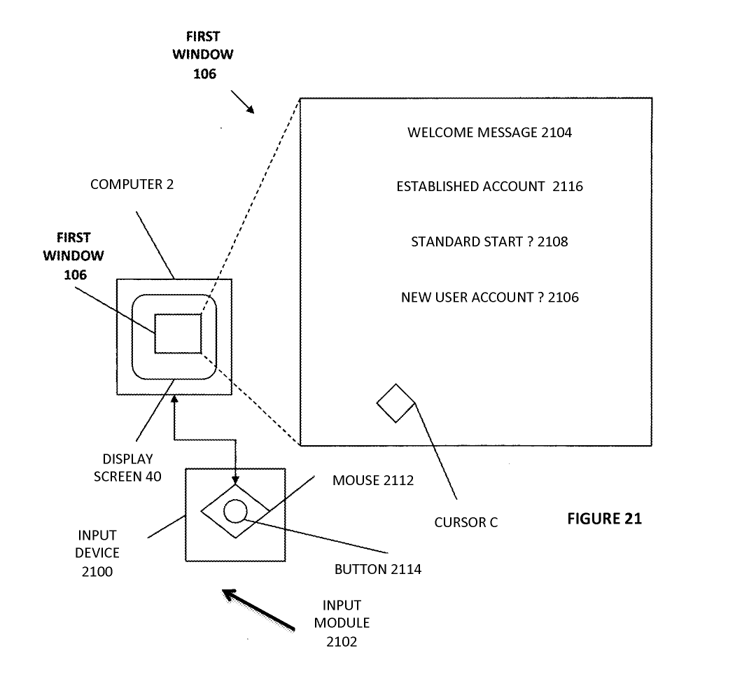

When the computer 2 determines in step 1904 that the current boot-up process is a first boot-up of an out-of-the box experience provided by the computer 2, the computer 2 proceeds from step 1904 to step 1914 and to cause a display screen 40 to display a first window 106 of FIG. 21. The computer 2 determines in step 1916 whether a user directs the computer 2 to apply default values to continue the boot-up process or to form a user account 112.A-112.N to direct the boot-up process. When the computer 2 determines in step 1916 that the user directs the computer 2 to apply default values to continue the boot-up process, the computer 2 proceeds to step 1918 and the apply the default values in step 1918, and to render a start-up desktop image 108. In the standard rendering process of the start-up desktop image 108 a predestinated plurality of application icon display data 11O.A-11O.Z of the application icons 11O.A-11O.Z are visually displayed by the display screen 40 of the computer 2.

When the computer 2 determines in step 1916 that the user directs the computer 2 to form a new user account record 112.A-112.N (or “user account” 112.A-112.N), the computer 2 proceeds to step 1922 to query the user for preferences and user characteristics that are applied by the computer 2 to populate a new user account 112.A-112.N. In step 1924 the computer 2 receives information provided by the user and in step 1926 the computer 2 updates the new user account 112.A-112.N. It is that the information provided by the user may be provided as user selections from visually displayed menus windows 106, 112, 114, 116 and 118 and by alphanumeric data input. When the computer 2 determines in step 1928 that the user has directed the computer 2 to end the account information loop of steps 122 through 128, the computer 2 proceeds from step 1928 to step 1908. The instant user account 112.A-112.N populated in steps 122 through 128 is then applied in step 1908, wherein the computer 2 selects one or more application icon display data 11O.A-11O.Z from the plurality of application icon display data 11O.A-11O.Z at least partly on the basis of the information provided by the instant user account 112.A-112.N, and the computer visually displays the selected application icon display data 110.A-110.N on the display screen 40 in step 1910.

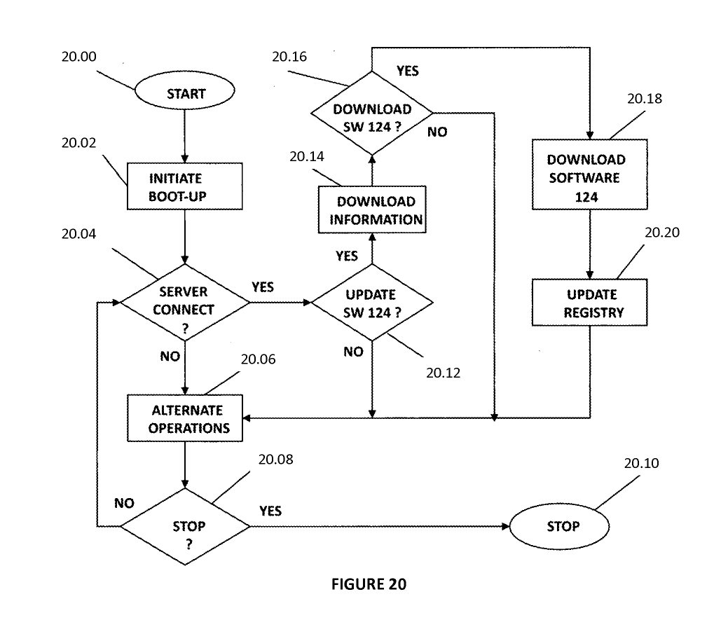

Referring now generally to the Figures and particularly to FIG. 20, FIG. 20 is a flowchart of a computer implemented process wherein a second aspect of the method of the present invention is practiced. In step 2000 the computer 2 receives a boot-up command and electrical power is provided to the computer 2. In step 2002 a boot-up process of the computer 2 is initiated. In step 2004 the computer 2 attempts to initiate a communications session with a remote server 32 via an electronics communication network 30. When the computer 2 determines that a communication session with the remote server 32 is not established in step 2004, the computer 2 proceeds from step 2004 to step 2006 and to perform alternate computational processes. The computer 2 proceeds from step 2006 to step 2008 and to determine whether to continue computational operations. When the computer 2 determines in step 2008 to continue computational operations, the computer 2 returns to step 2004 and to initiate a communications session with the remote server 32. When the computer 2 determines in step 2008 to not continue computational operations, the computer 2 proceeds to step 2010 and to power down.

When the computer 2 determines that a communication session with the remote server 32 is established in step 2004, the computer 2 proceeds from step 2004 to step 2012 and to determine whether the server 32 has an information update to provide to the computer 2. When the computer 2 determines in step 212 that the server 32 does not have an information update to provide to the computer 2, the computer 2 proceeds from step 212 to step 2006. Alternatively, when the computer 2 determines in step 2012 that the server 32 does have an information update to provide to the computer 2, the computer 2 proceeds from step 2012 to step 2014 and to download information from the server 32. The computer 2 proceeds from step 2014 to step 216 and to determine whether the server 32 has an application software update or new software to provide to the computer 2. When the computer 2 determines in step 2016 that the server 32 does not have an application software update or new software to download to the computer 2, the computer 2 proceeds to step 2006.

Alternatively, when the computer 2 determines in step 2016 that the server 32 has an application software update or new software to download to the computer 2, the computer 2 proceeds to step 2018 to download application software, software encoded instructions, information and/or software updates 124 and update a software registry 126 of the computer 2. The software registry 126 contains a plurality of software records 128.A-128.Z, wherein each software record 26.A-26.Z contains information relating to an individual software program 130.A-130.Z. An exemplary first software application 130.A when executed by the computer 2 enables the computer to access a web service in coordination with the server 32.

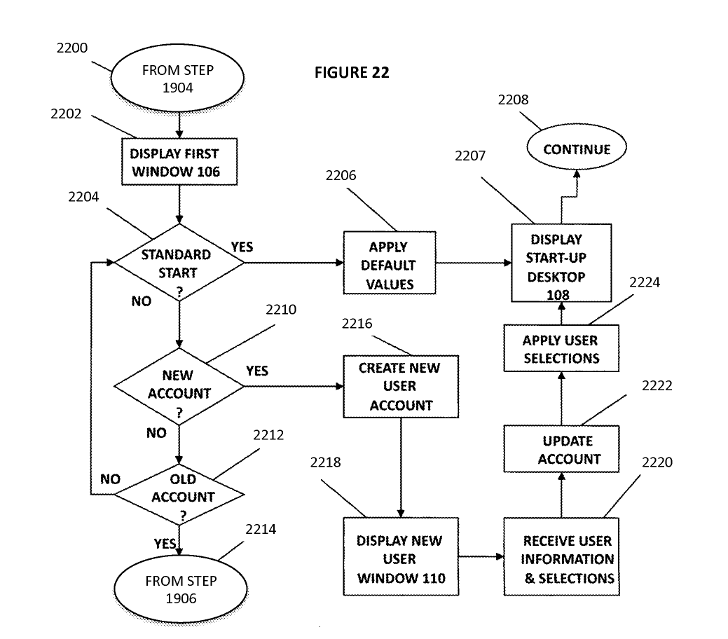

Referring now generally to the Figures and particularly to FIGS. 21 and 22, FIG. 21 is an illustration of a presentation by the computer 2 of an alternate visual aspect of the method of the present invention. The computer 2 includes an input device 2100 within an input module 2102 that includes an input device, e.g., a computer mouse, a digital keypad or keyboard, and/or a trackball module that the user uses to control the position of the cursor C within the display screen 40. The first window 106 includes an explanatory welcome message 2104 that explains that by creating a user account 112.A-102.Z the user may provide information useful to direct the computer 2 to provide a better boot-up experience, and/or a better out-of-the box experience, wherein the computer may both (a.) avoid presenting information to the user in the initial start-up desktop image 108 that is unlikely to be of interest to the user; and (b.) select and display information that is more likely to be of interest to the user in the initial start-up desktop image 108. The welcome message 2104 further explains that (a.) selecting the new user account option 2106 will enable the computer to create a user account 112.A-112.N by interaction with the user; and (b.) selecting the standard start TEXT 2108 will direct the computer 2 to present a standard listing of information to the user.

Referring now generally to the Figures and particularly to FIGS. 21 and 22, FIG. 22 is a flowchart of a computer implemented process wherein a still alternate aspect of the method of the present invention is practiced. The computer 2 proceeds from step 1904 of the process of FIG. 19 to display the first window 106 in the display screen 40 in step 2202. The computer determines in step 2204 whether the user has chosen the standard start option 2108 by means of the input module 2102, wherein the input module 2102 optionally comprises both an embodiment of the point and select device 20 and an embodiment of the text entry device 14. In one exemplary configuration of the computer 2, the input module 2102 comprises a computer mouse 2112 and the user positions the cursor C positioned by the computer 2 in response to a user's movement and manipulation of the computer mouse 2202 over a displayed text of a standard start option 2108 as displayed on the display screen 40, and the user additionally engages a selection button 2114 of the computer mouse 2202. The engagement of the selection button 2114 of the computer mouse 2112 thereby issues a command to the computer 2 to proceed from step 2204 to step 2206 and to apply default values to the boot-up process initiated in step 1902 of the process of FIG. 19. The computer 2 proceeds from step 2206 to step 2207 and to display the start-up desktop image 108 on the display screen 40. The computer 2 then proceeds from step 2207 to step 2208 to perform additional computational processes.

Alternatively, the computer determines in step 2210 whether the user has chosen the new account start text 2106 by means of the input module 2102. When a selection of neither the standard start 2108 is determined in step 2204, nor a selection of the new account start text 2106 is determined in step 2210, the computer 2 proceeds on to step 2212. Computer 2 determines in step 2212 whether the user has selected an established, i.e. an “old account”, from the first display window 106. When the computer 2 determines in step 2212 that the user has selected an established user account from the display first window 106, the computer 2 proceeds from step 2212 to step 2214 and to execute step 1906. When the computer 2 determines in step 2212 that the user has not selected an established user account from the display first window 106, the computer 2 proceeds from step 2212 to step 2204.

When the computer 2 determines in step 2210 whether the user has chosen the new account text 2106 by means of the input module 2102, the computer 2 proceeds to step 2216 and to create a new user account 112.A-112.N, and to display the new user window 112 in step 2218 via the display screen 40. The computer 2 receives information and menu item selections from the computer in step 2220, and in step 2222 the computer 2 updates and populates the user account 112.A-112.N created in step 2216 with the selections and information received the user. The computer 2 applies the instant user account 112.A-112.N in step 2224 in the boot-up process initiated in step 1902, wherein the information and menu item selections received in step 2220 are applied. The computer 2 proceeds from step 2224 to step 2207 and to display a start-up desktop image 108 on the display screen 40. The computer 2 then proceeds from step 2207 to step 2208 to perform additional computational processes.

It is noted that an established account selection option text 2116 for access to established account data may be optionally provided.

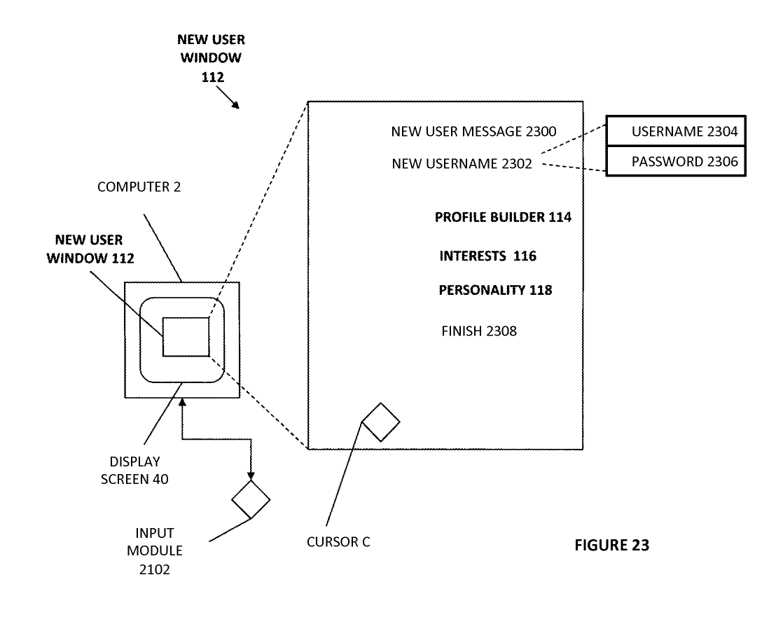

Referring now generally to the Figures and particularly to FIG. 23, FIG. 23 is an illustration of a presentation by the computer 2 of an alternate visual aspect of the method of the present invention. The new user window 112 includes a new user message 2300 that explains the function of the new user window 112 in enabling the user to populate a new user account 112.A-112.N. A new username option 2302 allows the user to input alphanumeric data from the input module 2102 to define a username 2304 and a password 2306. The new username 2304 and the password 2306 will be stored in, or associated with, the new user account 112.A-112.N.

The new user window 112 further contains click through options to the profile builder menu window 114, the interests menu window 116, the personality menu window 118, and a finish command 2308. A selection of the finish command by the user directs the computer 2 to cease populating the new account 112.A-112.N and proceed with the boot-up process.

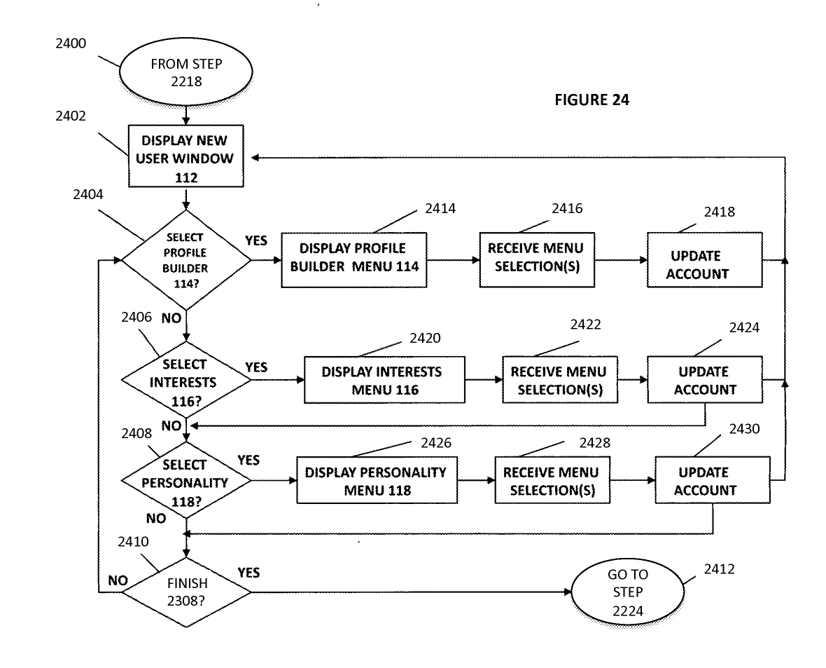

Referring now generally to the Figures and particularly to FIG. 24, FIG. 24 is a flowchart of a computer implemented process wherein a yet other aspect of the method of the present invention is practiced. The computer 2 proceeds from step 2218 of the process of FIG. 22 to step 2402 and displays the new user window in step 2202 by means of the display screen 40. The computer determines (a.) in step 2404 whether the user has selected the profile builder window 114; (b) in step 2406 whether the user has selected the interests window 116; (c.) in step 2408 whether the user has selected the personality menu window 118; and (d.) in step 2410 whether the user has selected the finish command 2308. When the computer 2 detects a user selection of the finish command 2308, the computer 2 proceeds on to step 2412 and to execute step 2224 of the process of FIG. 22.

When the computer 2 determines in step 2404 that the user has selected the profile builder window 114, the computer 2 proceeds from step 2404 to step 2416 to display the profile builder window 114; then to step 2416 to receive menu selections and information from the user; and then to step 2418 to update the exemplary new user account 112.A. The computer 2 proceeds from step 2418 back to execute step 2402 and to again display the new user window in step 2402 by means of the display screen 40.

When the computer 2 determines in step 2406 that the user has selected the interests window 116, the computer 2 proceeds from step 2406 to step 2420 to display the interests window 116; then to step 2422 to receive menu selections and information from the user; and ten to step 2424 to update the exemplary new user account 112.A with the menu selections and information received in step 2422. The computer 2 proceeds from step 2424 back to execute step 2402 and to again display the new user window in step 2402 by means of the display screen 40.

When the computer 2 determines in step 2408 that the user has selected the personality menu window 118, the computer 2 proceeds from step 2408 to step 2426 to display the personality menu window 118; then to step 2428 to receive menu selections and information from the user; and ten to step 2430 to update the exemplary new user account 112.A with the menu selections and information received in step 2426. The computer 2 proceeds from step 2430 back to execute step 2402 and to again display the new user window in step 2402 by means of the display screen 40.

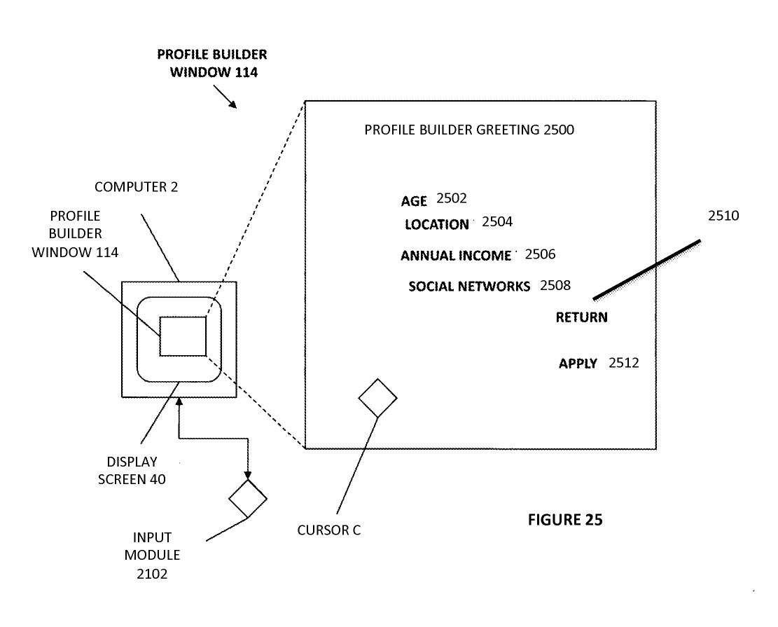

Referring now generally to the Figures and particularly to FIG. 25, FIG. 25 is an illustration of a presentation by the computer 2 of an additional visual aspect of the method of the present invention. The profile builder window 114 includes a profile builder greeting 2500 that explains to the user the function of the profile builder window 114 in gathering information that enables the computer 2 to personalize the start-up desktop image 108. An age option 2502 enables the user to input an age datum. A location option 2504 enables the user to input a location datum. An annual income option 2506 enables the user to input an annual income datum. A social networks option 2508 enables the user to input information related to a mediated electronic social network service, e.g., TWITTER™, FACEBOOK™ or MYSPACE™ social network service.

A return option 2510 allows the user to direct the computer 2 to return to the new user window 112. An apply option 2512 enables the user to direct the computer 2 to apply the exemplary new user account 112.A to generate the desktop start-up image 108.

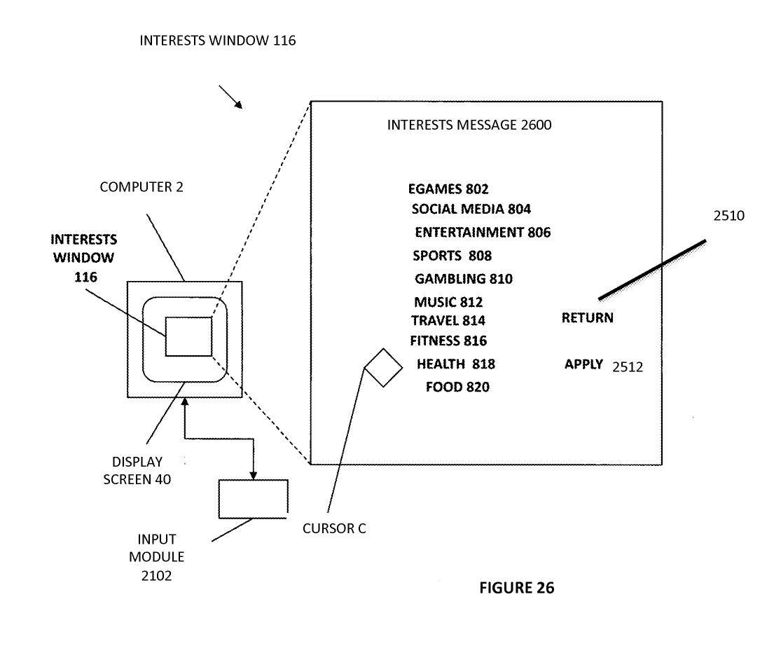

Referring now generally to the Figures and particularly to FIG. 26, FIG. 26 is an illustration of a presentation by the computer 2 of an even other alternate visual aspect of the method of the present invention. The interests window 116 includes an interests message 800 that explains to the user the function of the interests window 116 in gathering information that enables the computer 2 to personalize the start-up desktop image 108.

An egames interests descriptor 802 enables the user to direct the computer 2 to note within the exemplary user account 102 an interests in electronic games by the user; a social media interests descriptor 804 enables the user to direct the computer 2 to note within the exemplary user account 112.A an interest in social media by the user; an entertainment interests descriptor 806 enables the user to direct the computer 2 to note within the exemplary user account 112.A an interest in entertainment programs by the user; a sports interests descriptor 808 enables the user to direct the computer 2 to note within the exemplary user account 112.A an interest in sports by the user; a gambling interests descriptor 810 enables the user to direct the computer 2 to note within the exemplary user account 112.A an interest in gambling by the user; a music interests descriptor 812 enables the user to direct the computer 2 to note within the exemplary user account 112.A an interest in music by the user; a travel interests descriptor 814 enables the user to direct the computer 2 to note within the exemplary user account 112.A an interest in travel by the user; a fitness interests descriptor 816 enables the user to direct the computer 2 to note within the exemplary user account 112.A an interest in physical fitness by the user; a health interests descriptor 820 enables the user to direct the computer 2 to note within the exemplary user account 112.A an interest in personal health by the user; and a food interests descriptor 820 enables the user to direct the computer 2 to note within the exemplary user account 112.A an interest in food by the user.

Additional interests that the user may direct the computer 2 to note within the exemplary user account 112.A an interest by the user include technology, fashion, sports, health, and software.

The return option 710 allows the user to direct the computer 2 to return to the new user window 112; and the apply option 712 enables the user to direct the computer 2 to apply the exemplary new user account 112.A to generate the start-up image 108.

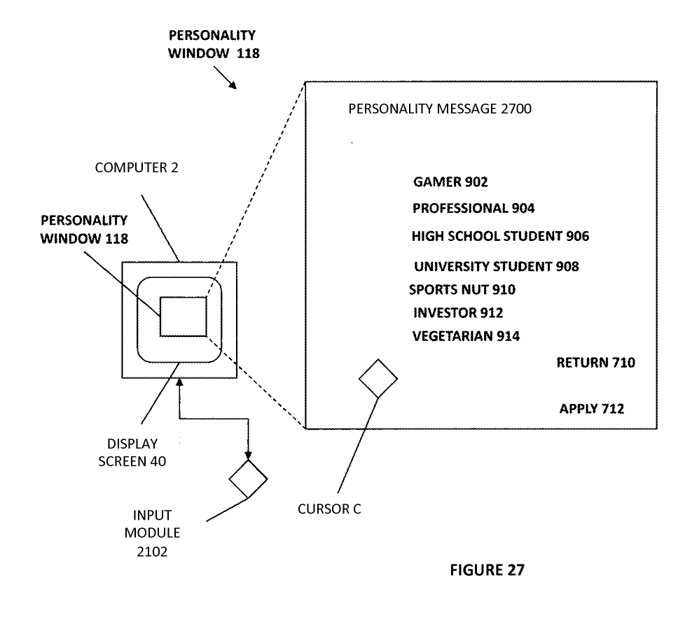

Referring now generally to the Figures and particularly to FIG. 27, FIG. 27 is an illustration of a presentation by the computer 2 of a yet other alternate visual aspect of the method of the present invention. The personality menu window 118 includes a personality message 900 that explains to the user the function of the personality descriptors 902-914, or “options” 902-914.

A gamer personality descriptor 902 enables the user to direct the computer 2 to note within the exemplary user account 112.A an interest in electronic games by the user; a professional personality descriptor 904 enables the user to direct the computer 2 to note within the exemplary user account 112.A a self-identification of the user as a professional; a high school student personality descriptor 906 enables the user to direct the computer 2 to note within the exemplary user account 112.A a self-identification of the user as a high school student; a University student personality descriptor 908 enables the user to direct the computer 2 to note within the exemplary user account 112.A a self-identification of the user as a University student; a sports nut personality descriptor 910 enables the user to direct the computer 2 to note within the exemplary user account 112.A a self-identification of the user as a sports enthusiast; an investor personality descriptor 912 enables the user to direct the computer 2 to note within the exemplary user account 112.A an interest in financial topics; and a vegetarian personality descriptor 914 enables the user to direct the computer 2 to note within the exemplary user account 112.A a self-identification of the user as a vegetarian.

Additional personality descriptors may enable the user to self-identify to the computer 2 as a small business manager, health care worker, technologist, child, shopper, retiree, senior and/or health care worker.

The return option 710 allows the user to direct the computer 2 to return to the new user window 112; and the apply option 712 enables the user to direct the computer 2 to apply the exemplary new user account 112.A to generate the desktop start-up image 108.

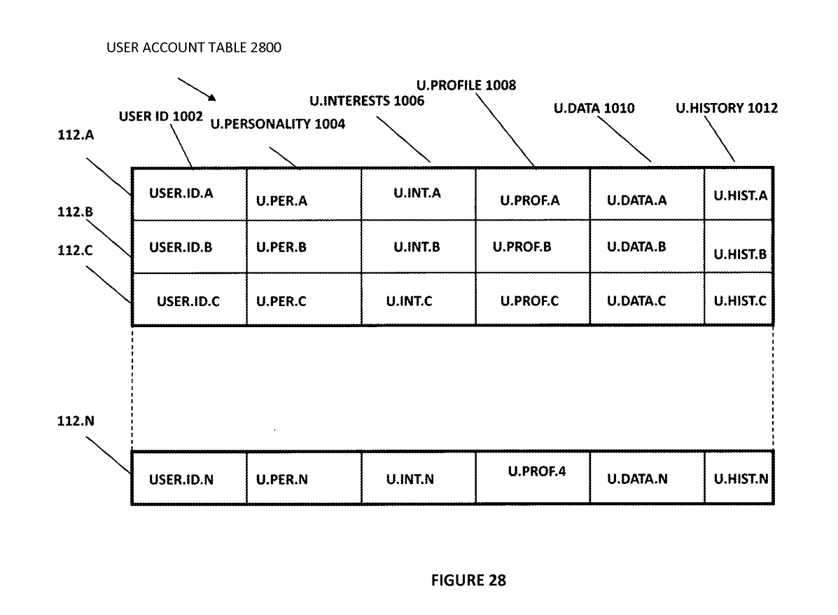

Referring now generally to the Figures and particularly to FIG. 28, FIG. 28 is a schematic of a presentation a user account table 2800 maintained by the computer 2. The user account table 2800 stores a plurality of user accounts 112.A-112.N. Each user account 112.A-112.N contains information that directs the computer 2 in rendering the boot-up desktop 108 of the computer 2. A default account record 112.N includes information accessed by the computer 2 in rendering the start-up desktop 108 when the user directs the computer 2 to apply default values in rendering the start-up desktop 108. A user identification data field 1002 of each user account 112.A-112.N optionally includes an identifier of a user, a user name and/or a password. Each user account 112.A-112.N includes a plurality of data fields of information associated with a user identified in the user identification data field 1002 of the user account 112.A-112.N comprising the individual user identification field.

A personality identification data field 1004 of each user account 112.A-112.N optionally includes information and selections U.PER.A-U.PER.N made by a user in interaction with the personality window 114. An interests identification data field 1006 of each user account 112.A-112.N optionally includes information and selections U.INT.A-U.INT.N made by a user in interaction with the interests window 116. A profile data field 1008 of each user account 112.A-112.N optionally includes information and selections U.PROF.A-U.PROF.N made by a user in interaction with the profile data builder window 118.

A user data field 1010 of each user account 112.A-112.N optionally includes information related to the user identified in the user identification data field 1002 of a same user account 111.A-112.N, and may include financial account information, language preferences and other user related data. A user history data field 1012 of each user account 112.A-112.N optionally includes information related to a history of interaction of user, as identified in the user identification data field 1002 of a same user account 112.A-112.N, with the computer 2, the server 32 and/or the electronics communication network 30.

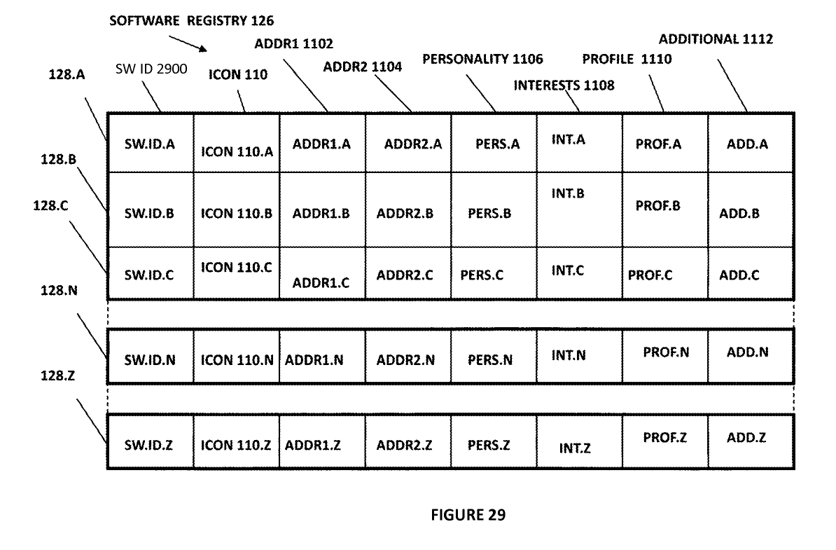

Referring now generally to the Figures and particularly to FIG. 29, FIG. 29 is a schematic of a presentation the software registry 126 maintained by the computer 2. As mentioned previously, the software registry 126 includes the plurality of software records 128.A-128.Z, wherein each software record 128.A-128.Z includes information related to an individual software program 128.A-128.Z identified in a software identification data field 1100 of the specific software record 128.A-128.Z. One or more individual software programs 128.A-128.Z may be stored in the computer 2, the server 32, the network 30, and/or a computer program product 132. The icon software 11O.A-11O.Z associated with the software program 128.A-128.Z identified in the software identification data field 1100, e.g., SW.ID.A-SW.ID.Z, of a same software record 128.A-128.Z. A first address data field 1102 identifies a first memory address ADDR1.A-ADDR1.Z within the computer 2, the server 32, the network 30, or the computer program product 132 at where at least a portion of the associated software program 130.A-130.Z is addressable. A second optional address data field 1104 identifies a second memory address ADDR2.A-ADDR2.Z within the computer 2, the server 32, the network 30, or the computer program product 132 at where at least a portion of the associated software program 130.A-130.Z is addressable. A registry personality data field 1106 includes personality matching data field PERS.A-PERS.Z, each personality matching data field PERS.A-PERS.Z for use by the computer 2 in separately evaluating an individual software program 130.A-130.Z for reference, by display of an associated application icon display data 11O.A-11O.Z, in the start-up desktop image 108. An interests data field 1108 includes interests matching data INT.A-INT.Z, each interests matching data INT.A-INT.Z for use by the computer 2 in separately evaluating an individual software program 130.A-130.Z for reference, by display of an associated application icon display data 11O.A-11O.Z, in the start-up desktop image 108. A profile data field 1110 includes profile matching data field PROF.A-PROF.Z, each profile matching data field PROF.A-PROF.Z for use by the computer 2 in separately evaluating an individual software program 130.A-130.Z for reference, by display of an associated application icon display data 11O.A-11O.Z, in the start-up desktop image 108.

An additional registry data field 112 additional data ADD.A-ADD.Z, each additional data ADD.A-ADD.Z for use by the computer 2 in separately evaluating an individual software program 130.A-130.Z for reference, by display of an associated application icon display data 110.A-110.Z, in the start-up desktop image 108. For example, the additional registry data field 112 may contain a display instruction directing the computer to always display a particular application icon display data 110.A-110.Z in the start-up desktop image 108, or a maintenance instruction prohibiting the computer 2 from deleting an associated software program 130.A-130.Z from the computer 2.

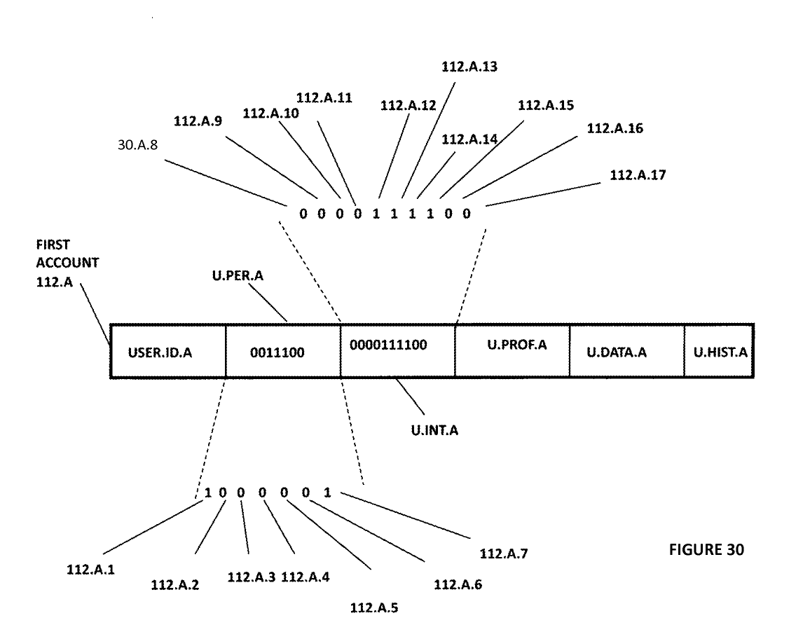

Referring now generally to the Figures and particularly to FIG. 30, FIG. 30 is a schematic diagram illustrating certain binary data 112.A.1-112.A.17 stored within the exemplary first user personality data field U.PER.A and the first user interests data field U.INT.A of the first user account 112.A. Each of a plurality of seven personality binary bits 112.A.1-112.A.7 of the first user personality data field U.PER.A indicate whether the user identified in the first user identification field USER.ID.A has self-identified as having a particular personality aspect identified by a named personality descriptor 902-914. In the exemplary application of a user account 112.A-112.N of step 2224 of the process of FIG. 22, (a.) a zero value 0 indicates that the user associated with a particular user account 112.A-112.N has not self-identified with the personality descriptor 902-914 associated with the zero value 0; and (b.) a one value 1 indicates that the user associated with a particular user account 112.A-112.N has self-identified with the personality descriptor 902-914 associated with the one value 1. For example, the first personality binary bit 112A.1 relates to the first personality descriptor gamer 902, and a one value 1 of the first personality binary bit 112A.1 would indicate that the user identified in the first user identification field USER.ID.A has self-identified as a gamer, whereas a zero value 0 of the first personality binary bit 112A.1 would indicate that the user identified in the first user identification field USER.ID.A has not self-identified as a gamer.

Furthermore, a user self-identification with the professional personality descriptor 904 is indicated by a one value 1 of the second binary bit 112.A.2; a user self-identification with the high school student personality descriptor 906 is indicated by a one value 1 of the third binary bit 112.A.3; a user self-identification with the University student personality descriptor 908 is indicated by a one value 1 of the fourth binary bit 112.A.4; a user self-identification with the sports nut personality descriptor 910 is indicated by a one value 1 of the fifth binary bit 112.A.5; a user self-identification with the investor personality descriptor 912 is indicated by a one value 1 of the sixth binary bit 112.A.6; and a user self-identification with the vegetarian personality descriptor 914 is indicated by a one value 1 of the seventh binary bit 112.A.7.

Alternatively, a lack of a user self-identification with the professional personality descriptor 904 is indicated by a zero value 0 of the second binary bit 112.A.2; a lack of a user self-identification with the high school student personality descriptor 906 is indicated by a zero value 0 of the third binary bit 112.A.3; a lack of a user self-identification with the University student personality descriptor 908 is indicated by a zero value 0 of the fourth binary bit 112.A.4; a lack of a user self-identification with the sports nut personality descriptor 910 is indicated by a zero value 0 of the fifth binary bit 112.A.5; a lack of a user self-identification with the investor personality descriptor 912 is indicated by a zero value 0 of the sixth binary bit 112.A.6; and a lack of a user self-identification with the vegetarian personality descriptor 914 is indicated by a zero value 0 of the seventh binary bit 112.A.7.

An analysis of the exemplary first user personality data field U.PER.A as illustrated in FIG. 30 indicates that the user identified in the first user identification data field USER.ID.A self-identifies with the gamer descriptor 902 by presenting a one value of the first personality binary bit 112.A.1; and with the vegetarian descriptor 914 by presenting a one value of the seventh personality binary bit 112.A.7. In contrast, the remaining second personality binary bit 112.A.2 through the sixth personality binary bit 112.A.6 of the exemplary first user personality data field U.PER.A present zero values 0 and thereby do not indicate a self-identification by the user with the remaining personality descriptors 904-912.

Each of a plurality of ten interests digital bits 112.A.8-112.A.17 of the first user interests data field U.INT.A indicate whether the user identified in the first user identification field USER.ID.A has self-identified as having a particular interests identified by a named interests descriptor 802-820. In the exemplary application of a user account 112.A-112.N of step 2224 of the process of FIG. 22, (a.) a zero value 0 indicates that the user associated with a particular user account 112.A-112.N has not self-identified with the interests descriptor 802-820 associated with the zero value 0; and (b.) a one value 1 indicates that the user associated with a particular user account 112.A-112.N has self-identified with the interests descriptor 802-820 associated with the one value 1. For example, the first interests binary bit 112A.8 relates to the first interests descriptor egames 802, and a one value 1 of the first interests binary bit 112A.8 would indicate that the user identified in the first user identification field USER.ID.A has self-identified as having an interest in egames, whereas a zero value 0 of the first interests digital bit 112A.8 would indicate that the user identified in the first user identification field USER.ID.A has not self-identified as having an interest in egames.

Furthermore, a user self-identification with the social media interests descriptor 804 is indicated by a one value 1 of the second interests binary bit 112.A.9; a user self-identification with the entertainment interests descriptor 806 is indicated by a one value 1 of the third interests binary bit 112.A.10; a user self-identification with the sports interests descriptor 808 is indicated by a one value 1 of the fourth interests binary bit 112.A.11; a user self-identification with the gambling interests descriptor 810 is indicated by a one value 1 of the fifth interests binary bit 112.A.12; a user self-identification with the music interests descriptor 812 is indicated by a one value 1 of the sixth interests binary bit 112.A.13; a user self-identification with the travel interests descriptor 814 is indicated by a one value 1 of the seventh interests binary bit 112.A.14; a user self-identification with the fitness interests descriptor 816 is indicated by a one value 1 of the eighth interests binary bit 112.A.15; a user self-identification with the a health interests descriptor 818 is indicated by a one value 1 of the ninth interests binary bit 112.A.16; and a user self-identification with the food interests descriptor 820 is indicated by a one value 1 of the tenth interests binary bit 112.A.17.

Alternatively, a lack of user self-identification with the social media interests descriptor 804 is indicated by a zero value 0 of the second interests binary bit 112.A.9; a lack of user self-identification with the entertainment interests descriptor 806 is indicated by a zero value 0 of the third interests binary bit 112.A.10; a lack of user self-identification with the sports interests descriptor 808 is indicated by a zero value 0 of the fourth interests binary bit 112.A.11; a lack of user self-identification with the gambling interests descriptor 810 is indicated by a zero value 0 of the fifth interests binary bit 112.A.12; a lack of user self-identification with the music interests descriptor 812 is indicated by a zero value 0 of the sixth interests binary bit 112.A.13; a lack of user self-identification with the travel interests descriptor 814 is indicated by a zero value 0 of the seventh interests binary bit 112.A.14; a lack of user self-identification with the fitness interests descriptor 816 is indicated by a zero value 0 of the eighth interests binary bit 112.A.15; a lack of user self-identification with the a health interests descriptor 818 is indicated by a zero value 0 of the ninth interests binary bit 112.A.16; and a lack of user self-identification with the food interests descriptor 820 is indicated by a zero value 0 of the tenth interests binary bit 112.A.17.

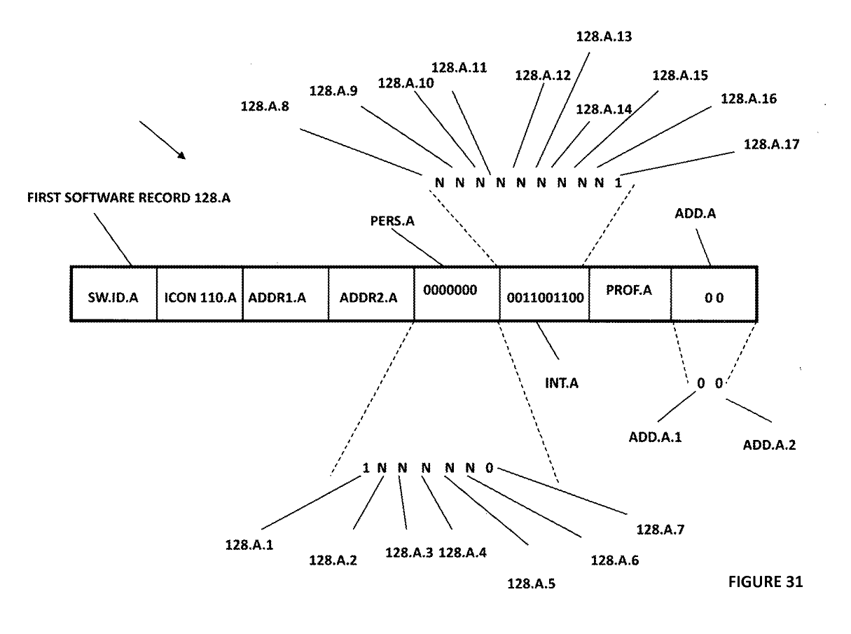

Referring now generally to the Figures and particularly to FIG. 31, FIG. 31 is a schematic diagram illustrating a plurality of software match binary data 128.A.1-128.A.17 stored within the exemplary first personality matching data PERS.A and the first interests matching data field INT.A of the exemplary first software record 128.A. Each of a plurality of seven personality match binary bits 128.A.1-128.A.7 of the first matching personality data field PERS.A indicate whether the first software 130.A is denoted for presentation to a user having self-identified with a particular personality aspect identified by a named personality descriptor 902-914. For example, when a first personality match binary bit 128.A.1 presents a one value, the computer 2 will include the first application icon display data 11O.A within the start-up desktop image 108 when the user account 112.A-112.N selected in step 2212 or applied in step 2224 of the process of FIG. 22 includes a first personality binary bit 112.A presents a one value 1, and will not present the first application icon display data 11O.A within the start-up desktop image 108 when the first personality match binary bit 128.A.1 presents a one value and the first personality binary bit 112.A presents a zero value 0 or a null value.

In another aspect of the plurality of software match binary data 128.A.1-128.A.17, a second personality match binary bit 128.A.2 may present a null value N, wherein the process of FIG. 22 in steps 2212 and 2224 will not consider the value of the second personality bit 112.A.2 of the first account 112.A, wherein neither a zero value 0 nor a one value 1 will neither inhibit the computer 2 from selecting, nor direct the computer 2 to select, the first application icon display data 11O.A in the start-up desktop image 108.

The exemplary first software record 128.A includes the seven personality match binary bits 128.A.1-128.A.7 of the first personality data filed PERS.A and a plurality of ten interests match binary bits 128.A.8-128.A.17 of the first interests data field INT.A. The first personality match bit 128.A.1 of the first software record 128.A presents a one value 1; the seventh personality match bit 128.A.7 presents a zero value 0; and the remaining second personality match bit 128.A.2 through the sixth personality match bit 128.A.6 of the first software record 128.A each present null values N. The first interests match binary value 128.A.8 through the ninth interests match binary value 128.A.16 each present a null value N; and the tenth interests match value 128.A.17 presents a one value 1.

When the computer 2 applies the first software record 128.A with any user account 112.A-112.N in an execution of a step 2212 or 2224, a match will be found whenever the following three states are all found to exist: (1.) the first personality binary bit 112.N.1 presents a one value 1, (2.) the seventh personality binary bit 112.N.7 presents a zero value 0, and (3.) the tenth interests binary bit 112.N.17 presents a one value 1. It is understood that the values of the remaining user account binary bits 112.N.3-112.N.16 will be irrelevant to the determination of a match by the computer 2. It is understood that a determination of a match by the computer 2 between a selected user account 112.A-112.N and any software record 128.A-128.Z directs the computer 2 to render an icon data 11O.A-11O.Z associated with the matching software record 128.A-128.Z in the start-up display image 108.

It is further understood that matches may be arrived at by the computer by comparing profile data of a user profile U.PROF.A-U.PROF.N of a user account 112.A-112.N with a software account profile data PROF.A-PROF.Z of the software records 128.A-128.Z.

Each software record 128.A-128.Z may further comprise a first additional bit ADD.A.1 and a second additional bit ADD.A.2, wherein when the first additional bit ADD.A.1 is set to a one value, 1, the computer 2 is directed to always render an icon data 11O.A-11O.Z in the start-up desktop image 108 regardless of the application or selection of a user account 112.A-112.N. The computer 2 may further be inhibiting a deletion form the computer 2 of software program 130.A-130.Z associated with a software record 128.A-128.Z when the second additional bit ADD.2 of the associated software record 128.A-128.Z presents a one value 1. It is understood that in certain variations of the method of the present invention, the zero value 0 or the null value N may be used in place of the one value 1 and with the same effect, in the first additional bit ADD.A.1 and/or the second additional bit ADD.A.2.

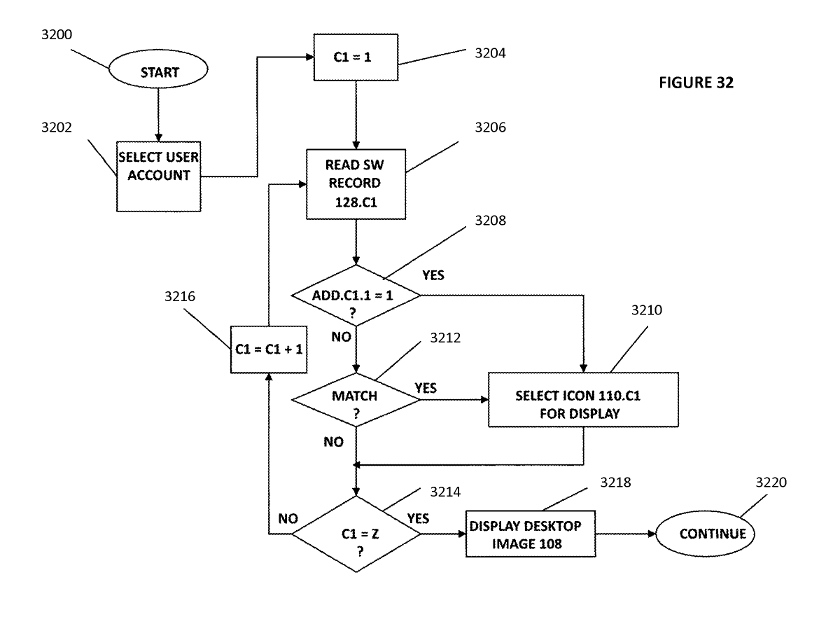

Referring now generally to the Figures and particularly to FIG. 32, FIG. 32 is a flowchart of a computer implemented process wherein an even additional aspect of the method of the present invention is practiced. The computer 2 as directed by a user selects a user account 112.A-112.N in step 3202 and then sets a first counter C1 to a one value 1 in step 3204. The computer 2 selects the instant software record 128.C1 from the software registry 126 in step 3206 and reads the first additional bit ADD.C1.1 of the instant software record 128.C1 to determine whether the value of the instant first additional bit ADD.C1.1 is set to direct the computer 110 to display the icon 110.C1 of the instant software record 128.C1 even without a match condition existing between the user account 112.A-112.N and the instant software record 128.C1. When the additional bit ADD.C1.1 read in step 3208 is equal to a value indicating an instruction to automatically render the icon 110.C1, e.g., a one value 1 in the process of FIG. 32, the computer 2 proceeds from step 1308 to step 3210 and selects the icon 110.C1 of the instant software record 128.C1 for rendering within the start-up desktop image 108.

When the instant additional bit ADD.C1.1 read in step 3208 is not equal to value indicating an instruction to automatically render the icon 110.C1, e.g., a zero value 0 in the process of FIG. 32, the computer 2 proceeds to step 3212 and then compares values of the instant software record 128.C1 with the user account selected in step 3202. When the computer 2 determines in step 3212 that a match exists between the instant software record 128.C1 with the user account 112.A-112.N selected in step 3202, the computer 2 proceeds from step 3212 to step 3210 and selects the icon 110.C1 of the instant software record 128.C1 for rendering in the start-up desktop image 108. The computer 2 proceeds from step 3210 or step 3212 to step 3214 and to determine whether the instant software record 128.C1 is the last software record 128.Z in the software registry 126.

When the computer 2 determines in step 3214 that the instant software record 128.C1 is not the last software record 128.Z in the software registry 126, the computer 2 proceeds to step 3216 to increment the value of the first counter C1 and the from step 3216 to step 3206 and to read a succeeding software record 128.C1 from the software registry 126.

When the computer 2 determines in step 3214 that the instant software record 128.C1 is the last software record 128.Z in the software registry 126, the computer 2 proceeds to step 3218 and to render the desktop image 108 on the display screen 40.

In step 3218 the computer 2 also informs the server 32 of the software programs 130.A-130.Z for which associated icon data 110.A-110.Z that is rendered in step 3218. The computer 2 further informs the server 32 of the software programs 130.A-130.Z that are selected for launch from the desktop image 108 in step 3222. The computer 2 proceeds from step 3218 and to step 3220 and to perform additional computational operations.

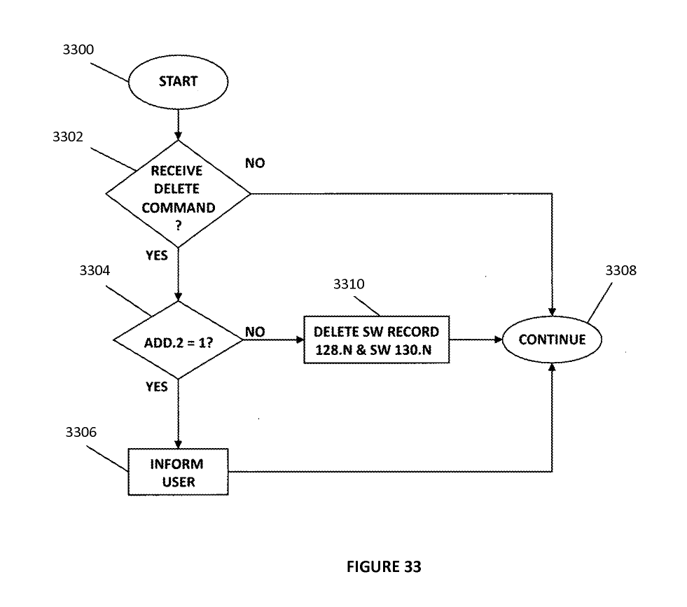

Referring now generally to the Figures and particularly to FIG. 33, FIG. 33 is a flowchart of a computer implemented process wherein a yet other additional aspect of the method of the present invention is practiced. In step 3302 the computer 2 determines a command to delete a specified software program 130.A-130.Z, has been received by the computer 2. When the computer 2 detects in step 3302 a receipt of a command to delete a specific software program 130.A-130.Z, or “instant software program” 130.N., the computer 2 proceeds on to step 3304.

The computer 2 reads the second additional bit ADD.A.2-ADD.N.2 of the software record 128.N associated with the instant software program 130.N in step 3304. When the second additional bit ADD.A.2-ADD.N.2 indicates that the computer 2 is prohibited from deleting the instant software program 130.N, the computer 2 proceeds from step 3304 to step 3306 and to inform the user by means of a message sent to the display screen 40 that the computer 2 is not authorized to delete the instant software program 130.N. The computer 2 proceeds from step 3306 and to step 3308 and to perform additional computational operations.

When the second additional bit ADD.A.2-ADD.N.2 indicates that the computer 2 is not prohibited from deleting the instant software program 130.N, the computer 2 proceeds from step 3304 to step 3310 to delete the instant software program 130.N and the associated software record 128.N from the software registry 126. The computer 2 proceeds from step 3310 and to step 3308 and to perform additional computational operations.

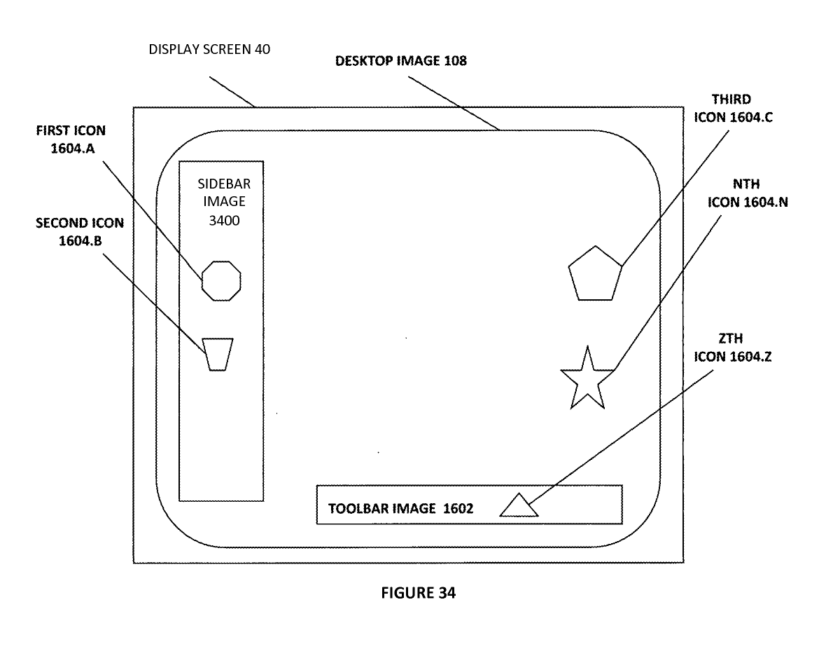

Referring now generally to the Figures and particularly to FIG. 34, FIG. 34 is an illustration of the start-up desktop image 108 as rendered in part from the plurality of application icon display data 11O.A-11O.Z of the software records 128.A-128.Z of the software registry 126. A sidebar image 1600 and a toolbar image 1602 are also rendered by the computer 2 and within the desktop image 108 as visually presented by the display screen 40. A plurality of software program launch icons 1604.A-1604.Z are further rendered within the desktop 108 by the computer 2. Each of the plurality of the software program icons 1604.A-1604.Z are rendered from a corresponding icon display data 11O.A-11O.Z. For example, the first software program launch icon 1604.A is rendered from the first icon display data 11O.A of the first software record 128.A. For another example, the second software program icon 1604.8 is rendered from the second icon display data 110.8 of the second software record 128.8. In addition, the third software program launch icon 1604.C is rendered from the third icon display data 110.C of the third software record 128.C. Furthermore, the Nth software program launch icon 1604.N is rendered from the Nth icon display data 11O.N of the Nth software record 128.N, and the last software program launch icon 1604.Z is rendered from the last icon display data 11O.Z of the last software record 128.Z.

A selection of a software program launch icon 1604.A-1604.Z may be affected by the user by manipulation of the computer mouse, whereupon a software program 130.A-130.Z associated with a selected launch icon 1604.A-1604.Z. In one example, when the network 30 comprises the Internet, a user selection of the first launch icon 1604.A directs the computer 2 to run the first software program 130.A, wherein the computer 2 may access a web service of the network 30. In one example, when the network 30 comprises an electronics communications network, a user selection of the second launch icon 1604.8 directs the computer 2 to run the first software program 130.A wherein the computer 2 initiates a communications session with the server 32 via the network 30.

Referring now generally to the Figures and particularly to FIG. 35, FIG. 35 is an additional schematic diagram of the computer 2 presenting an optional firmware 350. The firmware 350 further includes a set of software-encoded instructions comprising a basic input output system 3502, or “BIOS” 3502, used to boot-up the computer 2. The communications bus 4 bi-directionally communicatively couples the CPU 6, the firmware 3500, a display interface 3504, the input module 2102, the network interface 16, the memory 9, and the media reader 12. The display interface 3504 bi-directionally communicatively couples the display device 10 comprising the display screen 40 with the communications bus 4.

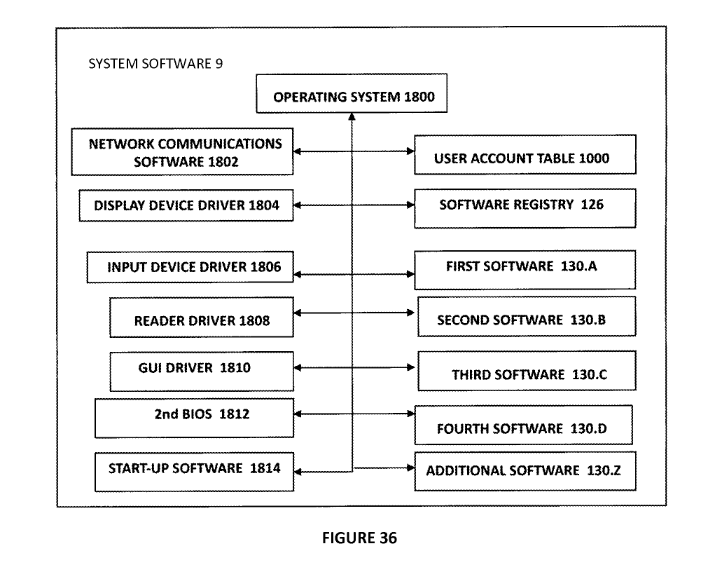

Referring now generally to the Figures and particularly to FIG. 36, FIG. 36 is a schematic diagram of the system software 9 of the computer 2. An operating system 1800 that acts as a control layer between the hardware elements of the computer 2 and the software of the computer 2. A network communications software 1802 enables the network interface 16 to bi-directionally couple the electronic communications network 30 with communications bus 4 and the CPU 6. A display device driver 1804 enables the CPU 6 to direct the state of the display screen 40 to include the rendering of the start-up desktop image 108. An input driver 1806 enables the CPU 6 to accept, execute and interpret commands, instructions, data and selections from the input module 2102. A reader driver 1808 enables the CPU 6 to accept, execute and interpret software-encoded programs, commands, instructions, data and selections from the media 22.

A graphical user interface driver 1810, or “GUI” 1810, enables the computer 2 to visually render data, e.g., to render the start-up desktop image 108. An optional 2nd BIOS element 1812 that may affect the execution of the basic input output system 352 that. A start-up system software 1814 enables the computer 2 to execute or perform one or more aspects of the processes of the Figures.

The system software 9 further includes the user account table 2800, the software registry 126, and the plurality of software applications 130.A-130.Z.

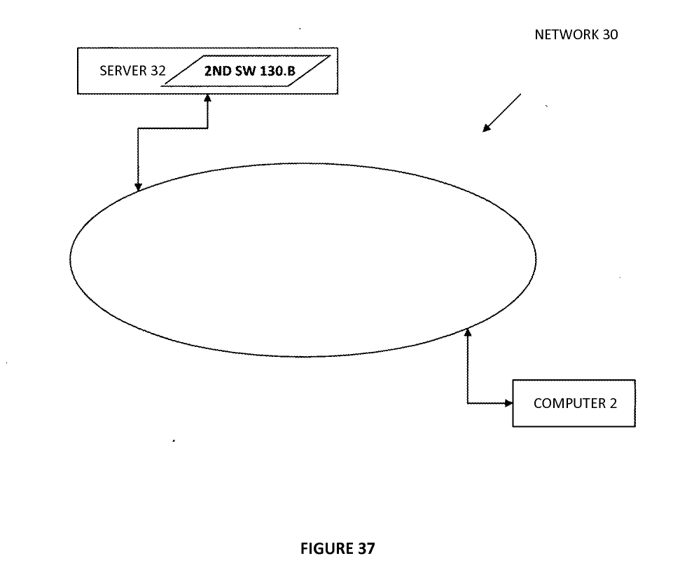

Referring now generally to the Figures and particularly to FIG. 37, FIG. 37 is a schematic diagram of the network 30. The server 32 may include one or more applications software 130.A-130.Z that may be downloaded via the network 30 to the computer 2.

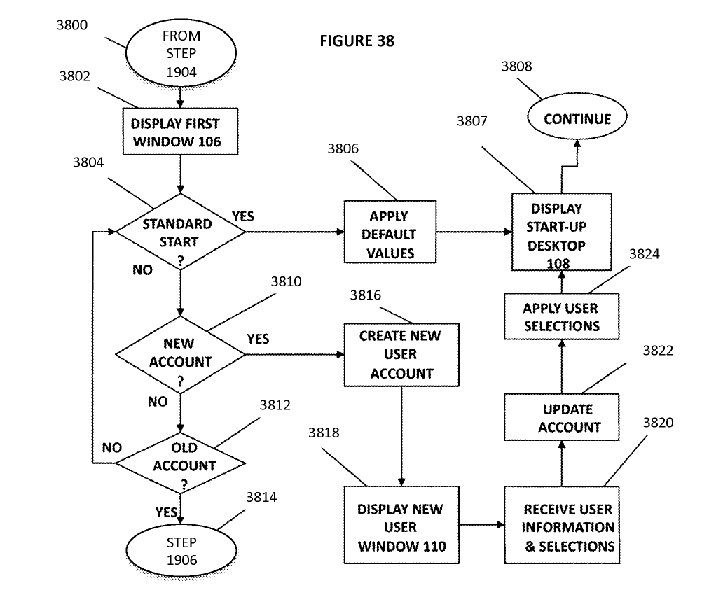

Referring now generally to the Figures and particularly to FIG. 38, FIG. 38 is a flowchart of a computer-implemented process wherein a still alternate aspect of the method of the present invention is practiced when the computer 2 is offline and/or not in communication with the network 30 and/or the remote server 32. The computer 2 proceeds from step 1904 of the process of FIG. 19 to display the first window 106 in the display screen 40 in step 3802. The computer determines in step 3804 whether the user has chosen the standard start option 308 by means of the input module 2102. In one exemplary configuration of the computer 2, the input module 2102 comprises a computer mouse 312 and the user positions the cursor C over the displayed text of the standard start option 310 as displayed on the display screen 40, and the user additionally engages a selection button 314 of the computer mouse 312. The engagement of the selection button 314 of the computer mouse 312 thereby issues a command to the computer 2 to proceed from step 3804 to step 3806 and to apply default values to the boot-up process initiated in step 1902 of the process of FIG. 19, wherein the default values are stored in the memory 8 or a memory element 132 or 1702 comprised within or accessible to the computer 2. The computer 2 proceeds from step 3806 to step 3807 and to display the start-up desktop image 108 on the display screen 40. The computer 2 then proceeds from step 3807 to step 3808 to perform additional computational processes.

Alternatively, the computer determines in step 3810 whether the user has chosen the new account start 310 by means of the input module 2102. When a selection of the standard start 308 is not determined in step 3804, nor a selection of the new account start 310 is determined in step 2010, the computer 2 proceeds on to step 2012. Computer 2 determines in step 2012 whether the user has selected an established, I.e. an “old account”, from the first display window 106. When the computer 2 determines in step 2012 that the user has selected an established user account from the display first window 106, the computer 106 proceeds from step 2012 to step 2014 and to execute step 1906. When the computer 2 determines in step 2012 that the user has not selected an established user account from the display first window 106, the computer 2 proceeds from step 2012 to step 3804.

When the computer determines in step 2010 whether the user has chosen the new account start 310 by means of the input module 2102, the computer 2 proceeds to step 2016 and to create a new user account 112.A-112.N, and to display the new user window 112 in step 2018 via the display screen 40. The computer 2 receives information and menu window item selections from the computer in step 2020, and in step 2022 the computer 2 updates and populates the user account 112.A-112.N created in step 2016 with the selections and information received the user. The computer 2 applies the instant user account 112.A-112.N in step 2024 in the boot-up process initiated in step 1902, wherein the information and menu window item selections received in step 2020 are applied. The computer 2 proceeds from step 2024 to step 3807 and to display a start-up desktop image 108 on the display screen 40. The computer 2 then proceeds from step 3807 to step 3808 to perform additional computational processes.

According to the method of FIG. 38, user selection and access to modify the software registry 126 and the user account table 2800 are enabled while the computer 2 is offline and not in communication with the network 30 and/or the remote server 32. Further according to the method of FIG. 35, user selection and access to modify and/or run the software applications 130.A-130.Z are enabled while the computer 2 is offline and/or not in communication with the network 30 and/or the remote server 32. Even further according to the method of FIG. 35, one or several of the aspects of the methods of FIGS. 1 through 16 are enabled while the computer 2 is offline and/or not in communication with the network 30 and/or the remote server 32. Alternately or additionally, according to the method of FIG. 20, one, several or all of the aspects of the methods of FIGS. 1 through 16 may be instantiated or performed by the computer 2 and without informational input or direction from the network 30 and/or the remote server 32.

According to other additional aspects of the method of the present invention, the system software 9 and the computer 2 enables a user to direct the computer 2 while the computer 2 is offline and not in communication with the network 30 and/or the remote server 32, to (a.) modify the software registry 126 and/or the user account table 2800; and/or to modify and/or run one or more software applications 130.A-130.Z. The terms of “condition” and “term” are defined as synonyms within their definition as applied within the present disclosure. The terms of “additional condition” and “additional term” are defined as synonyms within their definition as applied within the present disclosure. The terms of “conditions” and “terms” are defined as synonyms within their definition as applied within the present disclosure. The “conditions” and “additional terms” are defined as synonyms within their definition as applied within the present disclosure.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a non-transitory computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based herein. Accordingly, the disclosure of the embodiments of the invention is intended to be illustrative, but not limiting, of the scope of the invention, which is set forth in the following claims.

What is claimed is:

1. A computer-implemented method comprising:
initiating a boot-up of a computer:
receiving information from the user by the computer prior to rendering a start-up desktop image;
selecting at least one launch icon for display by the computer at least partly on the basis of the received information;
completing the boot-up process; and
displaying the at least one launch icon within a start-up desktop image.

2. The method of claim 1, wherein the boot-up process is within an out-of-the-box experience of the user.

3. The method of claim 1, wherein displaying the at least one launch icon is accomplished within the boot process.

4. The method of claim 1, further comprising downloading at least one software encoded instruction associated with the at least one launch icon via an electronic communications network.

5. The method of claim 1, wherein the at least one software program is deleted form the computer at least partly on the basis of the received information.

6. The method of claim 1, further comprising transmitting at least a datum of the received information via an electronics communication network to a server.

7. The method of claim 1, further comprising informing a server via an electronics communication network of the selection of the at least one launch icon.

8. The method of claim 1, further comprising receiving a launch command by the computer; and informing a server via an electronics communication network of the launch command receipt.

9. The method of claim 1, wherein the information comprises an indication by the user of an interest selected from the group of interests essentially comprising electronic games, gambling, food, travel, technology, music, news, financial news, fashion, sports, health, medical, legal, professional and software.

10. The method of claim 1, wherein the information comprises an indication by the user of a user type selected from the group of user types essentially comprising professional, small business manager, health care worker, technologist, child, high school student, University student, electronic gamer, shopper, retiree, senior and health care worker.

11. The method of claim 1, further comprising: initiating a bi-directional communications session with a server via an electronic communications network after the at least one launch icon is displayed; and providing additional software encoded instructions to the computer form the server.

12. The method of claim 11, wherein the application of the additional software encoded instructions by the computer occurs within a succeeding boot-up of the computer.

13. The method of claim 11, wherein the additional software encoded instructions direct the computer to offer access to an additional computational functionality.

14. The method of claim 13, wherein the additional computational functionality is a web service.

15. The method of claim 1, further comprising receipt by the computer of a launch command, wherein the launch command is associated with the at least one launch icon.

16. The method of claim 15, further comprising the computer initiating a communication session with a server via an electronics communications network in response to receipt by the computer of the launch command.

17. An information technology system comprising:
one or more processors;
at least one network interface configured to bi-directionally communicatively couple the information technology system with an electronics communications network;
a memory accessible by the at least one of the one or more processors;
a display module configured to visually display information received from the memory or the at least one network interface;
a process operated by the one or more processors to manage software program selection, the process being effective to:
initiate a boot-up of the information technology system:
request personalizing information from a user;
receive personalizing information from the user prior to rendering a start-up desktop image;
select at least one launch icon for display by the information technology system at least partly on the basis of the received information;
complete the boot-up process; and
display the start-up desktop image comprising the at least one launch icon by means of the display module.

18. The information technology system of claim 17, wherein the at least one network interface configured to bi-directionally communicatively couple the information technology system with the Internet.

19. The information technology system of claim 17, wherein the process is further effective to delete at least one software encoded instruction at least partly on the basis of the received information.

20. A non-transitory computer program product comprising:
a computer operable medium having computer readable code, the computer readable code being effective to:
initiate a boot-up of the information technology system:
receive information from the user prior to rendering a start-up desktop image;
select at least one launch icon for display by the information technology system at least partly on the basis of the received information;
complete the boot-up process; and
display the start-up desktop image comprising the at least one launch icon by means of the display module.
